(19) United States
(12) Patent Application Publication
(10) Pub. No.: US 2009/0177428 A1
(43) Pub. Date: Jul. 9, 2009

(54) Method of Measuring Peripheral Tilt Angle, Method and Device for Inspecting Inspection Object Having Surface Mounds, Method of Determining Position of Illumination Means, Irregularity Inspection Device, and Light Source Position Determining Device

(75) Inventor: Tamon Iden, Nara (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 12/227,562

(22) PCT Filed: Jun. 12, 2007
(86) PCT No.: PCT/JP2007/061842

§ 371 Date: Nov. 21, 2008

(30) Foreign Application Priority Data
Jun. 12, 2006 (JP) 2006-162889
Dec. 7, 2006 (JP) 2006-331059

(51) Int. Cl. G01P 21/00; G01B 11/26; G01B 11/30

(52) U.S. Cl. 702/94; 356/138; 356/600

(57) ABSTRACT

The method of measuring a peripheral tilt angle in accordance with the present invention, to address the problems, is a method of measuring a peripheral tilt angle on an inspection object having surface mounds, the method including: the step A of projecting light onto the inspection object; the step B of sensing distribution of light reflected off the inspection object; the step C of obtaining a feature point of the distribution of the reflected light from result of the sensing of the distribution of the reflected light; and the step D of obtaining a peripheral tilt angle which is a tilt angle near a periphery of each of the surface mounds based on an angle of projection of the light in step A to a position which, on the inspection object, corresponds to the feature point and an angle of sensing of the reflected light in step B off a position which, on the inspection object, corresponds to the feature point. Thus, the invention provides a method whereby a peripheral tilt angle, or a tilt angle of a surface mound near its periphery on an inspection object is obtained and also provides a method whereby deviation in height of the surface mound is precisely inspected based on the peripheral tilt angle.

### TECHNICAL FIELD

The present invention relates to methods of measuring a peripheral tilt angle, methods and devices for inspecting an inspection object having surface mounds, methods of determining positions of illumination means, irregularity inspection devices, and light source position determining devices.

### BACKGROUND ART

Liquid crystal displays have become larger in size in recent years. Demand for such displays is ever growing. However, price needs to be cut to see more widespread use of liquid crystal displays. There is an increasing demand to cut down on the cost of, especially, the color filter, which is a relatively expensive component in the liquid crystal display. Improvement of yield is very important because it directly affects cost. Demand is high for precise detection of defects in color filters.

A serious problem with the color filter is a linear irregularity which develops in a specific direction due to deviations in thickness of the color filter (deviations in height of surface mounds). To prevent irregularities from occurring when an image is displayed on the liquid crystal display, the deviation in thickness of the color filter needs to be not in excess of a few tens to a few hundreds of nanometers.

A known method of detecting deviation in thickness is an optical inspection method. The deviation in thickness as small as a few tens to a few hundreds of nanometers, however, cannot be detected by simply projecting light and capturing regular reflection with a camera. A solution to this problem is to utilize scattered light to detect a deviation in thickness, instead of disposing the light source and the camera to capture regular reflection on the camera. The precision of inspection by this method largely depends on the way the positions of the camera and the light source are specified. If the camera is not optimally positioned, the precision may deteriorate and vary across the frame. Other problems also follow.

As a method of specifying the positions of the camera and the light source, for example, patent document 1 discloses a method of determining the position of the camera by using a calibrator of a unique shape. Specifically, light is projected to a calibrator of which the shape is known to capture images. The position of the camera is calibrated according to results of the imaging.

Meanwhile, patent document 2 discloses a system including a line sensor camera. The orientation of the line sensor camera is controlled so as to maintain the camera at an optimal angle of elevation looking over an inspection object, while moving a stage carrying the inspection object.

### [Patent Document 1]

Japanese Unexamined Patent Publication No. 2005-202268 (Tokukai 2005-202268; published Jul. 28, 2005)

### [Patent Document 2]

Japanese Unexamined Patent Publication No. 5-302820/1993 (Tokukaihei 5-302820; published Nov. 16, 1993)

### DISCLOSURE OF INVENTION

The method disclosed in patent document 1, using a calibrator, makes it possible to specify positions for the camera and the light source relative to a certain reference so as to detect deviation in thickness. However, in inspection of a linear irregularity caused by deviation in thickness, a problem with the color filter, the method described in patent document 1 does not work well. A position of the camera and a captured waveform obtained by imaging the calibrator does not have one-to-one correspondence because the optimal position of the light source changes with the size of dots on the color filter, ink material, and other factors. Therefore, the method of patent document 1 cannot be utilized in inspection of the color filter. In addition, if the camera is moved, other problems also follow: The resolution of captured image may change. The focus may need to be adjusted. The optical axis may be displaced.

The method disclosed in patent document 2 takes time to calculate an optimal angle of elevation. This is undesirable. The angle of elevation seriously impacts inspection precision and hence requires close attention and careful setup. A device embodying the method of patent document 2 would be highly complex.

Meanwhile, if a peripheral tilt angle, which is a tilt angle near the periphery of a surface mound on the color filter or a like inspection object, is known, for example, in detection of a deviation in height of the surface mound, optimal relative positions of the illumination means, inspection object, and sensing means can be determined based on that tilt angle.

The present invention, conceived in view of these problems, has an objective of providing a method of obtaining a peripheral tilt angle, that is, a tilt angle near the periphery of a surface mound on an inspection object having that and other surface mounds.

Another objective of the present invention is to provide a method of precisely inspecting deviations in height of the surface mounds based on the peripheral tilt angles.

A method of measuring a peripheral tilt angle in accordance with the present invention is, to address the problems, a method of measuring a peripheral tilt angle on an inspection object having surface mounds and includes: the step A of projecting light onto the inspection object; the step B of sensing distribution of light reflected off the inspection object; the step C of obtaining a feature point of the distribution of the reflected light from result of the sensing of the distribution of the reflected light; and the step D of obtaining a peripheral tilt angle which is a tilt angle near a periphery of each of the surface mounds based on an angle of projection of the light in step A to a position which, on the inspection object, corresponds to the feature point and an angle of sensing of the reflected light in step B off a position which, on the inspection object, corresponds to the feature point.

The peripheries of the surface mounds are where the amount of reflected light changes easily due to deviation in height of the surface mounds. The method obtains a point where the luminance of the reflected light starts to decrease, that is, a feature point in the distribution of the reflected light, and obtains a peripheral tilt angle at a position which, on the inspection object, corresponds to the feature point. The “peripheral tilt angle” in this specification is defined as an angle of a part of a surface of the surface mound where reflection occurs at a position which, on the inspection object, corresponds to a feature point of the sensed distribution of the reflection of the light projected onto the inspection object.

The surface mound where the amount of the reflected light shows a maximum change cannot be directly detected as will be detailed later. The tilt angle of the surface mound where the amount of the reflected light shows a maximum change can be obtained indirectly by obtaining the peripheral tilt angle. When the tilt angle of the surface mound where the amount of the reflected light shows a maximum change is known, it is possible to locate the light source at a position where the angle of projection equals the tilt angle. Therefore, it is possible to specify a position from which light can be projected so as to maximize the change in the amount of the reflected light off that surface mound caused by deviation in height of the surface mounds. Therefore, this method of determining the peripheral tilt angle provides a useful indicator for precise detection of deviation in thickness on the inspection object.

An inspection method of the present invention is such that the method is an inspection method of detecting a deviation in height of surface mounds on an inspection object and includes: the step A of projecting light onto the inspection object; the step B of sensing distribution of light reflected off the inspection object; the step C of obtaining a feature point of the distribution of the reflected light from result of the sensing of the distribution of the reflected light; the step D of obtaining a peripheral tilt angle which is a tilt angle near a periphery of each of the surface mounds based on an angle of projection of the light in step A to a position which, on the inspection object, corresponds to the feature point and an angle of sensing of the reflected light in step B off a position which, on the inspection object, corresponds to the feature point; and the step E of, using an inspection device including illumination means for projecting light onto the inspection object and sensing means for sensing reflection of the projected light off the inspection object, determining relative positions of the illumination means, the inspection object, and the sensing means so that the light projected onto the inspection object is reflected off a part of the inspection object which has a tilt angle greater than or equal to the peripheral tilt angle and also that the reflected light is incident to the sensing means.

The method determines optimal relative positions of the illumination means, the inspection object, and the sensing means so that the sensing means can sense the light reflected off a part, including the periphery, at which the amount of the reflected light changes easily due to deviation in height of the surface mounds. Therefore, the method precisely detects the deviation in height of the surface mounds.

The inspection method of the present invention is preferably such that the relative positions of the illumination means, the inspection object, and the imaging means are determined so that the sensing means is disposed on a line which is an extension of a path followed by the reflection of the light projected onto the inspection object off one of the surface mounds which, on the inspection object, has an angle between (a) the peripheral tilt angle and (b) a reflection plane disappearance angle which is an angle of a surface of that surface mound at a position which, on the inspection object, corresponds to a position where no light is observable according to the distribution of the reflected light.

The method determines optimal relative positions of the illumination means, the inspection object, and the sensing means so that the sensing means can sense the light reflected off a part from the periphery to a point where the reflection plane disappears, which is a part of the dot at which the amount of the reflected light changes easily due to deviation in height of the surface mounds. Therefore, the method precisely detects the deviation in height of the surface mounds.

The inspection method of the present invention is preferably such that the feature point is an inflection point in data obtained by one-dimensional projection of data on the distribution of the reflected light.

The method obtains a unique point at which the amount of change in the reflected light undergoes a special change, that is, a unique feature point, and obtains a peripheral tilt angle based on the unique feature point. Therefore, the method precisely detects the deviation in height of the surface mounds.

The inspection method of the present invention is preferably such that: the inflection point is obtained by subjecting to first differentiation the data obtained by one-dimensional projection of the data on the distribution of the reflected light for a first derivative and subjecting further to second differentiation a slope of luminosity distribution obtained by the first differentiation for a second derivative; and the second derivative equals 0 at the inflection point.

The method invariably identifies by the second differentiation the position of the inflection point obtained by the first differentiation. The method thus further cuts short the time taken to determine the optimal relative positions, of the illumination means, the inspection object, and the sensing means, which could vary from one inspection object to the other. The method also further improves inspection precision.

The inspection method of the present invention is furthermore preferably such that the inflection point is a point at which the first derivative has a minimum moving standard deviation in a two-dot-cycle range stretching over a point at which the second derivative equals 0.

The method obtains a point at which the second derivative equals 0 to roughly determine an inflection point and then obtains a point at which the first derivative has a minimum moving standard deviation in a two-dot-cycle range stretching over the roughly determined inflection point. Therefore, the position of the inflection point can be more invariably determined. The method thus further cuts short the time taken to determine the optimal relative positions, of the illumination means, the inspection object, and the sensing means, which could vary from one inspection object to the other. The method also further improves inspection precision.

The inspection method of the present invention is preferably such that: the inflection point is obtained by subjecting to first differentiation the data obtained by one-dimensional projection of the data on the distribution of the reflected light, subjecting to second differentiation a slope of luminosity distribution obtained by the first differentiation for a second derivative, and subjecting the second derivative to third differentiation for a third derivative; and the third derivative equals 0 at the inflection point.

The second derivative does not equal 0 under some conditions, depending on optical conditions and the state of the inspection object. The method is capable of determining the position of the inflection point even under such conditions because the method carries out not only second differentiation, but also third differentiation. That adds to the general applicability of the method in accordance with the present invention.

The inspection method of the present invention is furthermore preferably such that the inflection point is a point at which the second derivative has a minimum moving standard deviation in a two-dot-cycle range stretching over a point at which the third derivative equals 0.

The method obtains a point at which the third derivative equals 0 to roughly determine an inflection point and then obtains a point at which the second derivative has a minimum moving standard deviation in a two-dot-cycle range stretching over the roughly determined inflection point. Therefore, the position of the inflection point can be more invariably determined. The method thus further cuts short the time taken to determine the optimal relative positions, of the illumination means, the inspection object, and the sensing means, which could vary from one inspection object to the other. The method also further improves inspection precision.

The inspection method of the present invention is preferably such that a method of obtaining the reflection plane disappearance angle is carried out by comparing the inspection object with a reference sample having a definite reflection plane disappearance position.

It may be difficult to directly detect the reflection plane disappearance position, depending on the shape of the inspection object. The method images a reference sample with a known reflection plane disappearance position or a reference sample of a shape from which the reflection plane disappearance position is easily obtainable and indirectly obtains the reflection plane disappearance position of the inspection object from the position of the inflection point of the reference sample, the reflection plane disappearance position, and the position of the inflection point of the inspection object by utilizing a proportional relationship. Thus, the method reduces effect of the shape of the inspection object. That adds to the general applicability of the method in accordance with the present invention.

The inspection method of the present invention is preferably such that the distribution of the reflected light is sensed at least twice.

The method generates, for example, at least two position determining images to determine the position of the inflection point based on the images. The method more accurately determines the position of the inflection point because the method uses more resources based on which the position of the inflection point is determined than in cases where there is only one position determining image being involved. The method thus further cuts short the time taken to determine the optimal light source positions which could vary from one inspection object to the other. The method also further improves irregularity detection precision of an irregularity inspection device.

The inspection method of the present invention is preferably such that the feature point is obtained based on reflection data on light reflected off particular surface mounds in the distribution of the reflected light.

The “particular surface mounds” are those corresponding to characteristics of the inspection object. For example, a color filter, in view of color, has three characteristics: namely, red, blue, and green. In that case, the “particular surface mounds” are, for example, those surface mounds which the red dots have, those which the blue dots have, and those which the green dots have. By inspecting based on reflection data on light reflected off particular surface mounds, deviation in thickness is inspected separately for the three colors. The method reduces hence effect of deviation in thickness caused by different ink materials and other reasons specific to each color, thereby further improving inspection precision.

The inspection method of the present invention is preferably such that: at least two different surface mounds are selected as the particular surface mounds; and a feature point is obtained for each of the particular surface mounds based on reflection data on light reflected off those surface mounds. The method focuses on at least two of the characteristics of the inspection object (for example, red, blue, and green of the color filter) and detects the particular surface mounds for each characteristic, thereby obtaining an inflection point (feature point) according to that characteristic. Therefore, the method precisely detects the deviation in height of the surface mounds.

The inspection method of the present invention is preferably such that the feature point(s) is/are obtained based on the data on the distribution of the reflected light for each color of the surface mounds.

Some types of color filters have a slightly different thickness from one color to the other; the inflection point (feature point) may change from one color to the other. Therefore, the optimal relative positions of the illumination means, the inspection object, and the sensing means may be determined for surface mounds of each color by selecting different particular surface mounds for each color.

The inspection method of the present invention is preferably such that when the feature point(s) is/are obtained based on the data on the distribution of the reflected light for each color of the surface mounds, the feature point(s) is/are obtained based on data other than the data on the distribution of the reflected light about halfway between two surface mounds of different colors.

For example, when particular surface mounds on an inspection object (e.g., a color filter) are selected for each color and the feature point(s) is/are obtained based on data on the distribution of the reflected light for each color, the colors of the surface mounds preferably do not overlap. The colors of two surface mounds of different colors may be mixed about halfway between the two surface mounds. The method obtains the feature point(s) based on mixed-color free data other than the data on the distribution of the reflected light about halfway between two surface mounds of different colors, thereby improving inspection precision. The method therefore more precisely determines optimal relative positions of the illumination means, the inspection object, and the sensing means for surface mounds of each color.

An inspection device of the present invention includes: illumination means for projecting light onto an inspection object having surface mounds; sensing means for sensing distribution of reflection off the inspection object onto which light is projected; feature point detection means for obtaining a feature point in the distribution of the reflection from result of the sensing of the distribution of the reflection; and tilt angle calculation means for obtaining a peripheral tilt angle which is a tilt angle near a periphery of each of the surface mounds based on an angle of projection of the light to a position which, on the inspection object, corresponds to the feature point and an angle of the sensing by the sensing means of the reflection off a position which, on the inspection object, corresponds to the feature point.

The device is capable of adjusting the position of the illumination means by obtaining a peripheral tilt angle which, near the periphery of the surface mound, is a part at which the amount of the reflected light changes easily due to deviation in height of the surface mounds, so that the light reflected off the periphery can be sensed by the sensing means. Therefore, the device precisely detects the deviation in height of the surface mounds.

A method of determining a position of illumination means in accordance with the present invention is implemented by an irregularity inspection device including illumination means for projecting light illuminating a linear part of a film surface and imaging means for receiving light reflected off the film surface onto which light is projected, in order to detect, on an inspection object including the film having very small, orderly arranged surface mounds, an irregularity caused by deviation in thickness in a specific direction of a surface mound from other surface mounds, the method including: the first step of projecting light onto the film on the inspection object; the second step of receiving the light reflected off the film on the inspection object to generate a position determining image; the third step of obtaining, based on the position determining image, a distance between an inflection point of luminance of the reflected light and a regular reflection position at which the projected light undergoes regular reflection off the film on the inspection object, to determine a position of the inflection point; the fourth step of determining a distance between the regular reflection position and a reflection plane disappearance position on the film at which the luminance of the reflected light equals 0 and which is next to a position where non-zero luminance is observed; the fifth step of obtaining a center position which is a halfway point between the position of the inflection point and the reflection plane disappearance position; the sixth step of obtaining a tilt angle of the film at the center position with respect to a plane of the inspection object by equation 1,

$$\begin{matrix}[ Eq . 1 ] & \\ {θ}_{c} = \frac{α - β}{2} \\ where \\ α = {tan}^{- 1} ( \frac{{L}_{1} + {X}_{c}}{{H}_{1}} ) \\ β = {tan}^{- 1} ( \frac{{L}_{2} - {X}_{c}}{{H}_{2}} ) & ( Eq . 2 )\end{matrix}$$

α is an angle between a normal to the plane of the inspection object passing through the center position and the light projected by the illumination means incident at the center position, and β is an angle between the normal and light reflected at the center position to the imaging means; and the seventh step of determining an optimal position of the illumination means for receiving the light reflected at the center position from the tilt angle by equation 2,

### [Eq. 2]

X_{L}=tan(2θ_{c}+θᵢ)·D cos θᵢ−D sin θᵢ (Eq. 3)

Generally, irregularities of, for example, a color filter are caused by a tilt angle of a peripheral face of an irregular dot when compared with normal dots. The amount of the reflected light changes at the part having that tilt angle. To detect deviations in thickness on the order of a few tens to a few hundreds of nanometers with an irregularity inspection device, it is necessary to detect a site in the part having the tilt angle where the amount of the reflected light undergoes a large change, capture a position determining image, and determine the position of the illumination means in the irregularity inspection device based on the position determining image.

When a linear part of a film surface of an inspection object having irregularities is illuminated with the illumination means being fixed to a position in the irregularity inspection device, the sufficient reflection plane off which light is reflected to the imaging means is continuous until one of orderly arranged films. Thereafter, however, the reflection plane starts decreasing and finally disappears. In other words, the amount of reflected light shows the greatest change at sites between a position where the reflection plane of the film starts decreasing and a position where the reflection plane disappears. Therefore, if the position of the illumination means is adjusted so as to illuminate these sites, it becomes possible to precisely inspect for irregularities.

The method of the present invention determines, based on the position determining image, the position of the inflection point, of the luminance of the reflected light, at which the reflection plane starts decreasing and the reflection plane disappearance position at which the reflection plane disappears. The method then obtains the tilt angle based on these positions. Thus, the method is capable of detecting a site where the amount of the reflected light undergoes a large change and determining the site as the position of the illumination means. The method thus cuts short the time taken to determine an optimal light source position which could vary from one inspection object to the other. The method also improves irregularity detection precision of the irregularity inspection device.

An irregularity inspection device in accordance with the present invention includes: illumination means for projecting light illuminating a linear part of a film surface of an inspection object including a film having very small, orderly arranged surface mounds; imaging means for receiving light reflected off the film surface onto which light is projected, to generate a position determining image; calibration means for determining, based on the position determining image, an optimal position of the illumination means, to receive light reflected at a center position which is a halfway point between an inflection point of luminance of the light reflected off the film surface and a reflection plane disappearance position on the film at which the luminance of the reflected light equals 0 and which is next to a position where non-zero luminance is observed; and inspection means for detecting an irregularity on the inspection object based on an irregularity inspection image obtained by receiving, on the imaging means, reflection off the inspection object of the light projected by the illumination means located at the determined position of the illumination means onto the inspection object.

The device detects a site where the amount of the reflected light undergoes a large change, determines the site as the position of the illumination means, and inspects for irregularities based on the irregularity inspection image produced by receiving the reflection of the light projected onto the inspection object from an optimal light source position. The device thus cuts short the time taken to determine the optimal light source position which could vary from one inspection object to the other. The device also achieves high irregularity detection precision. The device only needs to include the illumination means, the imaging means, the calibration means, and the inspection means. The device therefore does not require a complex structure. The device is relatively simple.

The irregularity inspection device in accordance with the present invention is preferably such that the calibration means includes: other illumination means for projecting light illuminating a linear part of the film surface and other imaging means for receiving light reflected off the film surface onto which light is projected, to generate a position determining image.

In the device, the calibration means includes illumination means and imaging means for use in determining the position of the illumination means that is provided in the irregularity inspection device, apart from the illumination means and the imaging means that are included in the irregularity inspection device for the detection of irregularities. The illumination means and the imaging means that are included for the detection of irregularities are moved less often. The device is thus capable of inspecting for irregularities in less time.

The irregularity inspection device in accordance with the present invention is preferably such that the imaging means is an area sensor camera or a line sensor camera. The area sensor camera is inferior to the line sensor camera in resolution and speed, but inexpensive. The area sensor camera, unlike the line sensor camera, requires no auxiliary scanning in which the inspection object is moved. Therefore, the area sensor camera is effective in simple inspection and contributes to cost reduction.

In contrast, the line sensor camera readily offers necessary high resolution, as well as superb signal SN ratios and dynamic ranges, delivering high quality images. In addition, auxiliary scanning is performed by moving the inspection target, which enables continuous, high-speed image capturing. Therefore, the line sensor camera is effective in high-precision inspection.

A light source position determining device in accordance with the present invention includes: illumination means for projecting light illuminating a linear part of a film surface of an inspection object including a film having very small, orderly arranged surface mounds; imaging means for receiving light reflected off the film surface onto which light is projected, to generate a position determining image; and calibration means for determining, based on the position determining image, an optimal position of the illumination means, to receive light reflected at a center position which is a halfway point between an inflection point of luminance of the light reflected off the film surface and a reflection plane disappearance position on the film at which the luminance of the reflected light equals 0 and which is next to a position where non-zero luminance is observed.

The device determines the position of the inflection point of the luminance of the reflected light and the reflection plane disappearance position based on the position determining image. The device then obtains the tilt angle based on these positions. Thus, the device is capable of detecting a site where the amount of the reflected light undergoes a large change and determining the site as the position of the illumination means. The device thus cuts short the time taken to determine the position of the light source for an irregularity inspection device. The device also improves irregularity detection precision of the irregularity inspection device.

Additional objectives, advantages and novel features of the invention will be set forth in part in the description which follows, and in part will become apparent to those skilled in the art upon examination of the following or may be learned by practice of the invention.

### BRIEF DESCRIPTION OF DRAWINGS

FIG. 1 A block diagram of an inspection device as an embodiment of the present invention.

FIG. 2 Plan views showing a layout direction for a color filter substrate (inspection object). In the figure, (a) is a top view of the device; (b) a cross-sectional view taken along the straight line indicated in (a) (parallel to the longer sides of the color filter substrate (inspection object)); (c) a top view of the device after an optimal position is determined for a first light source (illumination means) and the first light source (illumination means) is moved to the position; and (d) a cross-sectional view taken along the straight line indicated in (c) (parallel to the longer sides of the color filter substrate (inspection object)).

FIG. 3 Plan views illustrating a relationship between an arrangement on a color filter surface, a direction of a linear irregularity caused by deviation in thickness, and a scan direction for a line sensor camera (i.e., a moving direction of a stage). In the figure, (a) is a plan view showing a layout of dots 301 on the color filter; and (b) a plan view illustrating results of imaging in the presence of the deviation indicated in (a).

FIG. 4 Schematic illustrations showing changes of reflection off the color filter substrate (inspection object) of light projected by a second light source to the color filter substrate (inspection object). In the figure, (a) shows a cross section of the dots on the color filter substrate (inspection object); and (b) the surface of the dots in (a) as observed with a second camera (area sensor camera) disposed above the color filter substrate (inspection object).

FIG. 5 Graphs representing results of detection of an inflection point from projection data by mathematical differentiation. In the figure, (a) represents projection data; (b) results of calculation of the slope of a luminosity distribution by first differentiation of the projection data; and (c) results of detection of an inflection point by further, second differentiation of the slope.

FIG. 6 Graphs representing results of detection of an inflection point from projection data under the condition that the second derivative does not equal 0. In the figure, (a) represents projection data; (b) results of calculation of the slope of a luminosity distribution by first differentiation of the projection data; (c) results of further second differentiation of the slope; and (d) results of further third differentiation of the second derivative.

FIG. 7 Illustrations of a method of obtaining a reflection plane disappearance position for the color filter substrate (inspection object) using a reference sample.

FIG. 8 An illustration of a process of converting center position data to the tilt angle of a dot located at the center position.

FIG. 9 An illustration of a process of obtaining the position XL of a light source from the tilt angle θc of a dot.

FIG. 10 A flow chart depicting a method of determining the position of illumination means in accordance with the present invention.

FIG. 11 A flow chart depicting a process of interpolating with data in a dot cycle.

FIG. 12 Illustrations of a cross section of dots on a color filter substrate and one-dimensional projection data for distribution of reflected light where a dot is thicker than other dots.

FIG. 13 Illustrations of a cross section of dots on a color filter substrate and one-dimensional projection data for distribution of reflected light where a dot is thicker than other dots.

FIG. 14 An illustration of optimal relative positions for the illumination means, the inspection object, and the sensing means in accordance with the present invention.

FIG. 15 A plan view of arrangement of dots on a color filter surface.

FIG. 16 An illustration of imaging data (a) obtained by a first camera 201 and color component imaging data (b) to (d) obtained by extracting each color from imaging data (a).

FIG. 17 An illustration of how to measure the distance L from an edge 801 to a pixel on imaging data.

FIG. 18 Graphs representing data obtained by integrating imaging data for each color component.

FIG. 19 An illustration of an image capturing pixel area 901 of the first camera 201 and dots on a color filter of the first camera 201.

### BEST MODE FOR CARRYING OUT INVENTION

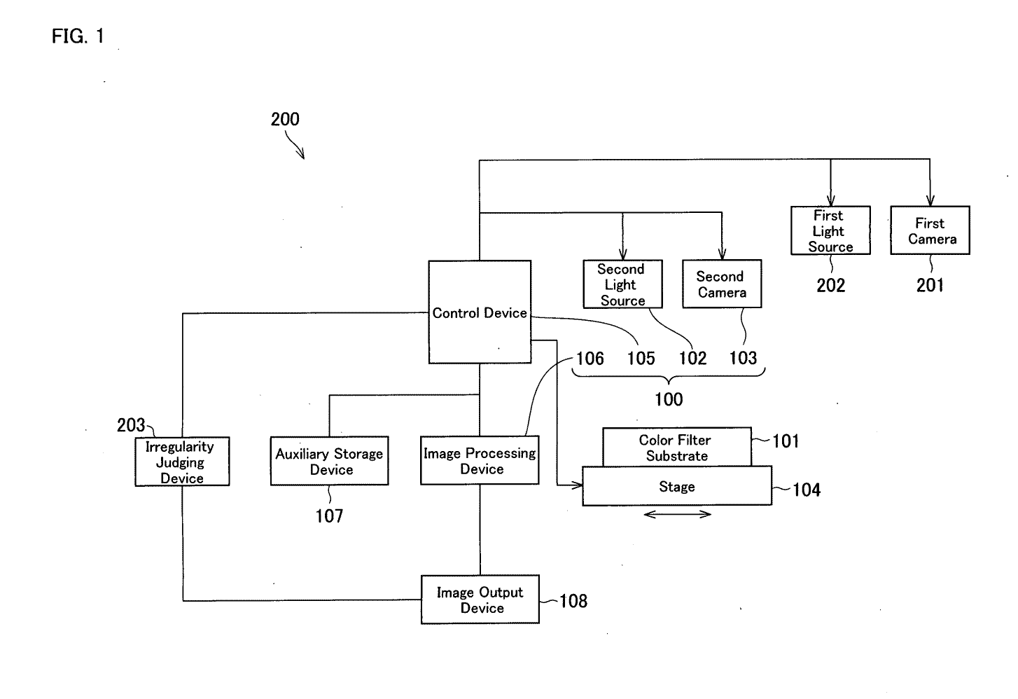

The following will describe embodiments of a method of measuring a peripheral tilt angle, a method and device for inspection, a method of determining the position of illumination means, an irregularity inspection device, and a light source position determining device in accordance with the present invention in reference to FIGS. 1 to 19.

The embodiments employ a color filter on which a cyclic, repeated pattern of unitary fine openings is formed. The inspection object having surface mounds is not limited in any particular manner: it only needs to have surface mounds which exhibit continuous change in angle.

Examples include a shadow mask used in a color television CRT, a color filter substrate used in a liquid crystal display, and a semiconductor which has a cyclic pattern. A preferred example is a rectangular color filter substrate carrying thereon dots arranged so that different colors (R, G, and B) of dots form different rows in a scan direction and a red, a green, and a blue dot line up next to each other in a direction perpendicular to the scan direction for the following reasons. The optimal positions for the camera and the light source in detecting a linear irregularity, which can often occur in the manufacture of a color filter and cause decreases in manufacturing efficiency, change with the size of the dots on the color filter, ink material, and other factors. Therefore, the position of the illumination means needs to be determined for each color filter.

The color filter substrate may be manufactured by a conventional, publicly known method. Examples include inkjet, lamination, spin coating, and roll coating.

### Embodiment 1

FIG. 1 is a block diagram of an inspection device 200 as an embodiment of the present invention. In the embodiment shown in FIG. 1, the inspection device 200 in accordance with the present invention includes a calibration device (calibration means, feature point detection means, tilt angle calculation means) 100, a first camera (sensing means, imaging means) 201, a first light source (illumination means) 202, an auxiliary storage device 107, an image output device 108, and an irregularity judging device (inspection means) 203.

The calibration device (calibration means, feature point detection means, tilt angle calculation means) 100 includes a second camera 103, a second light source 102, and an image processing device 106. The color filter substrate (inspection object) 101 is mounted to a stage 104 which can reciprocate along an axis parallel to the surface of the color filter substrate 101.

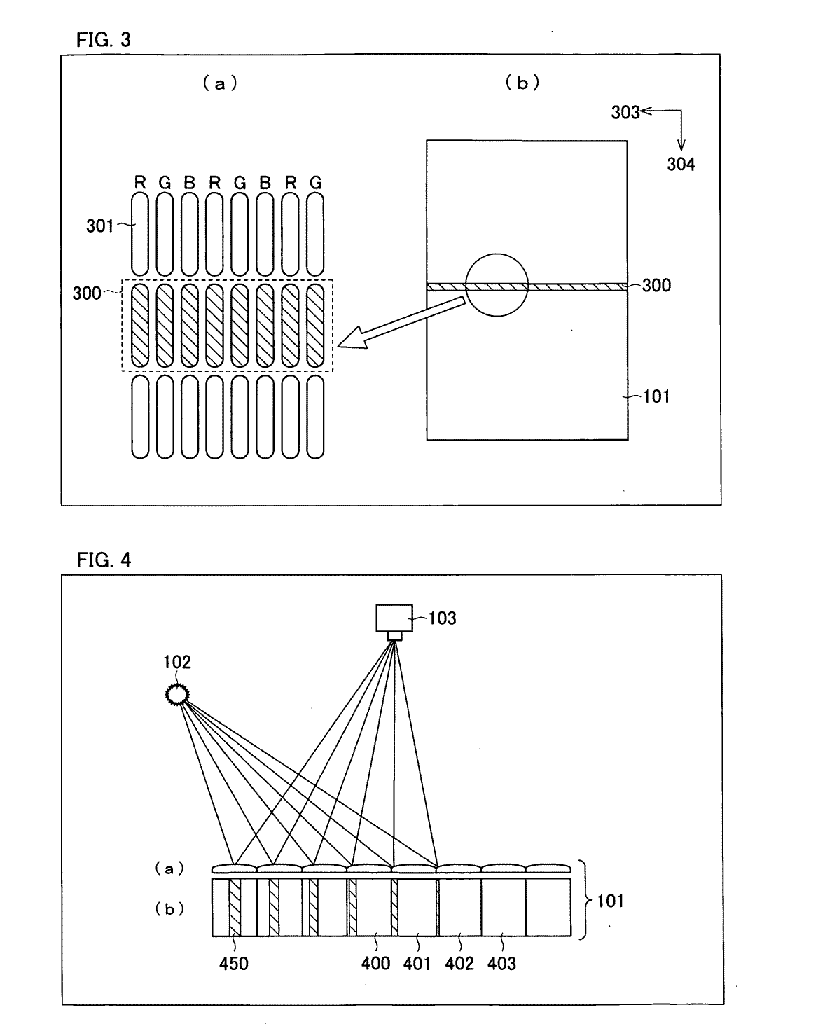

FIG. 3 is plan views illustrating a relationship between an arrangement on a color filter surface, a direction of a linear irregularity caused by deviation in thickness, and a scan direction for a line sensor camera (i.e., a moving direction of the stage 104). (a) of FIG. 3 is a plan view showing a layout of dots 301 on the color filter; (b) of FIG. 3 is a plan view illustrating results of imaging in the presence of the deviation in thickness indicated in (a) of FIG. 3.

The dots 301 on the color filter are arranged in a matrix with a red one, a green one, and a blue one appearing repeatedly in this order, as shown in (a) of FIG. 3. Suppose in the present embodiment that a preceding step has caused deviation in thickness in the row of dots 300 in (a) of FIG. 3. Under these circumstances, a linear irregularity 300 occurs in the horizontal direction (specific direction) as shown in (b) of FIG. 3. In this particular case, the linear irregularity occurs in a stage moving direction 304, that is, perpendicular to the moving direction of the stage 104.

The first camera (sensing means, imaging means) 201 and the second camera 103 are not limited in any particular manner. Any conventional, publicly known imaging means may be used. Examples include line sensor cameras and area sensor cameras. Suitable ones may be selected from line sensor cameras and area sensor cameras, which have properties mentioned above, in consideration of precision and other conditions in the irregularity inspection.

The first light source (illumination means) 202 and the second light source 102 are not limited in any particular manner. A line source is preferred to capture an image of a linear irregularity because the angle of projection varies less with the direction of linear irregularity. The line source can be, for example, a tubular light source (e.g. a fluorescence lamp). Alternatively, point sources, such as light emitting diodes (LEDs), may be arranged in a line to use them as a line source.

The second light source 102, one of components of the calibration device (calibration means, feature point detection means, tilt angle calculation means) 100, is used to determine an optimal position of the first light source (sensing means, illumination means) 202 in the inspection device 200 by a method of determining the position of illumination means in accordance with the present invention. The second camera 103 is provided to receive reflection off the color filter substrate (inspection object) 101 of the light projected by the second light source 102 to generate position determining images.

The calibration device (calibration means, feature point detection means, tilt angle calculation means) 100 does not necessarily include illumination means and imaging means. When the calibration device (calibration means, feature point detection means, tilt angle calculation means) 100 includes the second light source 102 and the second camera 103, the image processing device 106 determines an optimal position of the first light source (illumination means) 202 based on the position determining images obtained using the second light source 102 and the second camera 103.

In other words, in that case, the calibration device (calibration means, feature point detection means, tilt angle calculation means) 100 and the irregularity judging device (inspection means) 203 each includes a single illumination means and a single imaging means; the optimal position of the first light source (illumination means) 202 may be determined using only the first light source (illumination means) 202 and the first camera (imaging means) 201 provided in the inspection device 200.

The control device 105 is provided to move the first light source (illumination means) 202, the second light source 102, the first camera (sensing means, imaging means) 201, the second camera 103, and the stage 104 according to data on the inspection object 101 contained in the auxiliary storage device 107. The control device 105 may be a PC (programmable controller) or like sequencer, for example, a PLC (programmable logic control).

The “data on the inspection object 101 contained in the auxiliary storage device 107” is the data contained in the auxiliary storage device 107 that is associated with features of the inspection object 101: for example, the pitch of the color filter pattern (cycle of the dots), old inspection conditions for inspection objects, and inspection recipes.

The image processing device 106 is provided to determine an optimal position of the first light source (illumination means) 202 based on the position determining images obtained by receiving, using the first camera (sensing means, imaging means) 201 or the second camera 103, reflection off the color filter substrate (inspection object) 101 of the light projected by the first light source (illumination means) 202 or the second light source 102 onto the color filter substrate (inspection object) 101. Specific operation of the image processing device 106 will be detailed later.

The auxiliary storage device 107 is provided to store data on the color filter substrate (inspection object) 101. The auxiliary storage device 107 may be, for example, a hard disk in a PC (personal computer) or a similar storage medium. The image output device 108 is provided to display results of determining an optimal position of the first light source (illumination means) 202 and results of judging irregularities. The device 108 may be a liquid crystal monitor, a CRT, or a similar monitor.

Next will be described a process of determining the optimal position of the first light source (illumination means) 202 with the calibration device (calibration means, feature point detection means, tilt angle calculation means) 100. The calibration device (calibration means, feature point detection means, tilt angle calculation means) 100 determines, based on position determining images (detailed later), the optimal position of the illumination means for the first camera (sensing means, imaging means) 201 to receive reflection off a center position. The center position is a halfway point between an inflection point (feature point) in a graph obtained by one-dimensional projection of the luminance distribution of the reflection and a position on the film of the color filter substrate (inspection object) 101 where reflection has zero luminance (where no light is observable according to the distribution of the reflected light), the position being located next to a position where non-zero luminance is observed (hereinafter, “reflection plane disappearance position”). The method of determining the position of illumination means in accordance with the present invention can be implemented by using the calibration device (calibration means, feature point detection means, tilt angle calculation means) 100.

In other words, the calibration device (calibration means, feature point detection means, tilt angle calculation means) 100 can be used as a light source position determining device for determining an optimal position of the first light source (illumination means) 202.

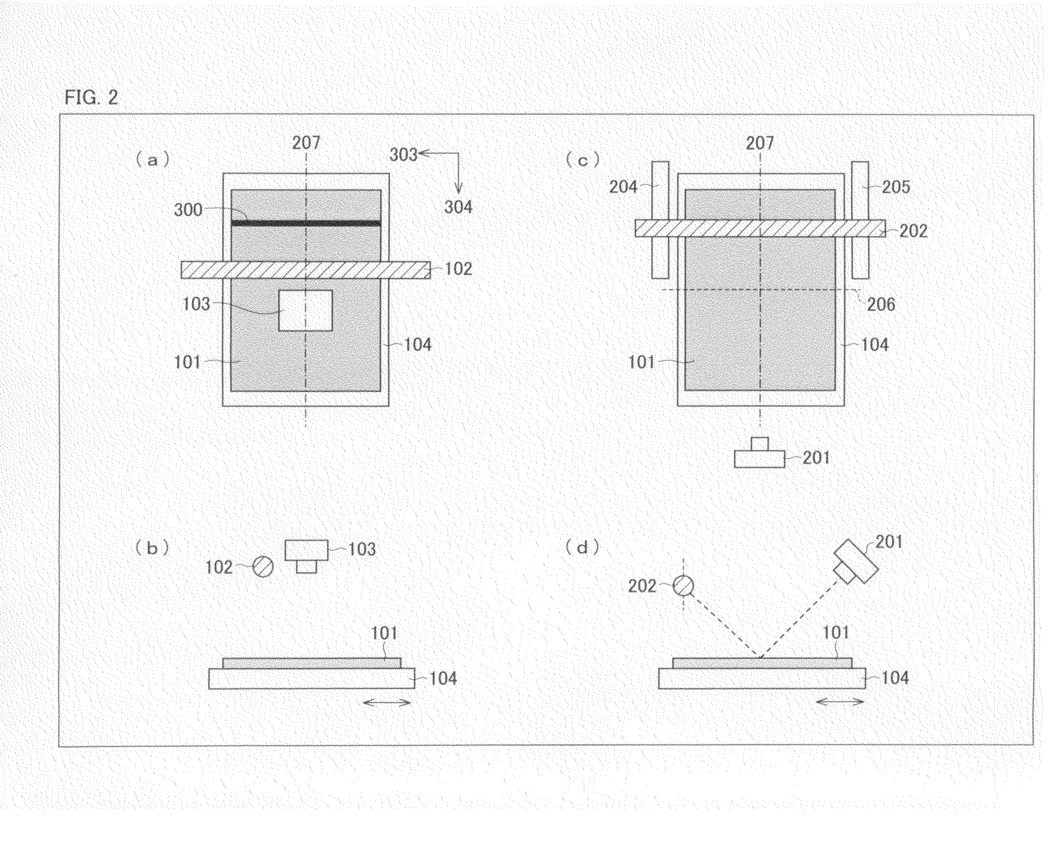

FIG. 2 is plan views showing a layout direction for a color filter substrate (inspection object) 101. (a) of FIG. 2 is a top view of the device; (b) of FIG. 2 a cross-sectional view taken along a straight line 207 (parallel to the longer sides of the color filter substrate 101) indicated in (a) of FIG. 2; (c) of FIG. 2 a top view of the device after an optimal position is determined for the first light source (illumination means) 202 and the first light source (illumination means) 202 is moved to the position; and (d) of FIG. 2 a cross-sectional view taken along a straight line 207 (parallel to the longer sides of the color filter substrate (inspection object) 101) indicated in (c) of FIG. 2.

As shown in (a) of FIG. 2, the color filter substrate (inspection object) 101 is provided on the stage 104 so that the stage moving direction 304, or the moving direction of the stage 104, is perpendicular to a linear irregularity direction 303. The second light source 102 and the second camera 103 are positioned so that the second camera 103 can receive the regular reflection of the light projected by the second light source 102 onto the color filter substrate (inspection object) 101.

That position for the regular reflection is the position where luminance is highest and can be readily determined using a publicly known technique. As an example, the second light source 102 is disposed parallel to the linear irregularity direction 303, and the second camera 103 is positioned so that an image of the second light source 102 is visible in the frame of the second camera 103. When this is the case, it is desirable to use as much of the frame as possible.

With these settings, if the second light source 102 projects light illuminating a linear part of the surface of the color filter substrate (inspection object) 101 which carries the dots 301, that is, the surface of the film on the color filter substrate (inspection object) 101, the line of illumination formed on the color filter substrate (inspection object) 101 is parallel to the linear irregularity direction 303.

The light which is projected by the second light source 102 onto the color filter substrate (inspection object) 101 and reflected off the color filter substrate (inspection object) 101 is received by the second camera 103 which generates position determining images. The number of the generated position determining images is not limited in any particular manner. To accurately determine inflection point (detailed later), it is preferable to generate two or more position determining images. In other words, it is preferable to sense the distribution of the reflected light at least twice or more.

Next, the image processing device 106 in the calibration device (calibration means, feature point detection means, tilt angle calculation means) 100 determines the optimal position of the first light source (illumination means) 202 based on the position determining images. FIG. 4 is a schematic illustration showing changes of reflection off the color filter substrate (inspection object) 101 of the light projected by the second light source 102 onto the color filter substrate (inspection object) 101.

(a) of FIG. 4 shows a cross section of the dots on the color filter substrate (inspection object) 101; and (b) of FIG. 4 the surface of the dots in (a) of FIG. 4 as observed with the second camera 103, or an area sensor camera, disposed above the color filter substrate (inspection object) 101. In other words, (b) of FIG. 4 is a schematic representing results of sensing of the distribution of the reflection off the color filter substrate (inspection object) 101.

As shown in (b) of FIG. 4, the dots on the color filter substrate (inspection object) 101 has a columnar cross section shown in (a) of FIG. 4 due to a cause in the preceding process. Of the dots shown in (b) of FIG. 4, those at the left-hand side (from the leftmost one to the dot 400) each have a sufficient reflection plane 450 where the light is reflected to the second camera 103. In other words, no influence of the black matrix which provides a dot-to-dot interface on the reflection is observed with these dots.

On the dot 401 which is next to the dot 400, the reflection plane 450 is formed closer to the black matrix and hence smaller, thereby reflecting less light. The trend continues with the dot 402, and the dot 403 has no reflection plane 450.

For the dots 401 to 403, a change in deviation in thickness produces a greater change in the amount of reflected light than for the other dots for reasons which will be detailed later. “Deviation in thickness (of the film)” is a synonym of “deviation in height of the surface mounds” throughout the specification.

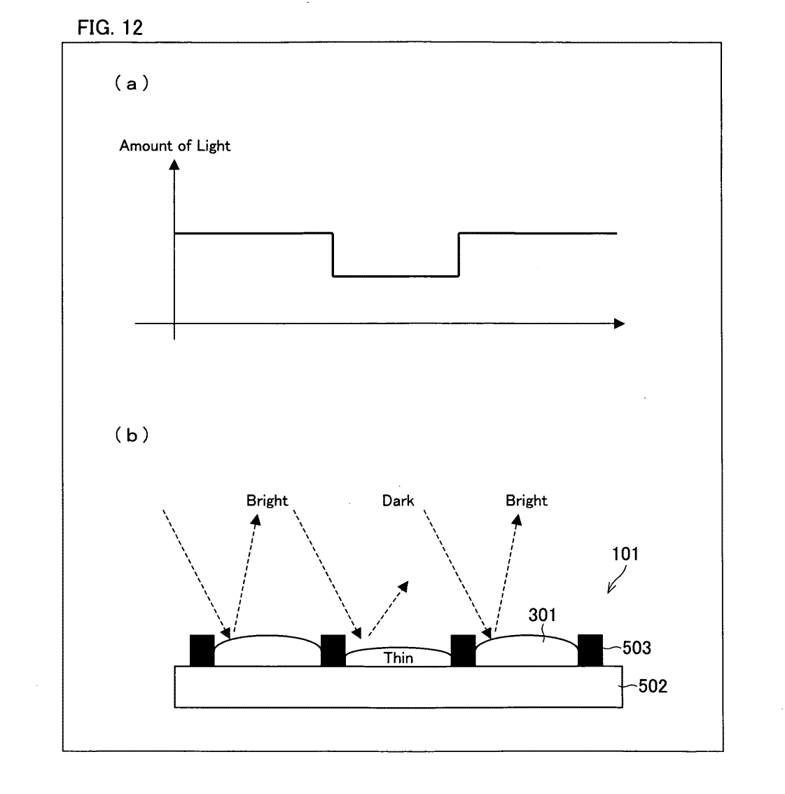

Next will be described why a change in deviation in thickness produces a greater change in the amount of reflected light for the dots 401 to 403 than for the other dots, in reference to FIGS. 12 to 14.

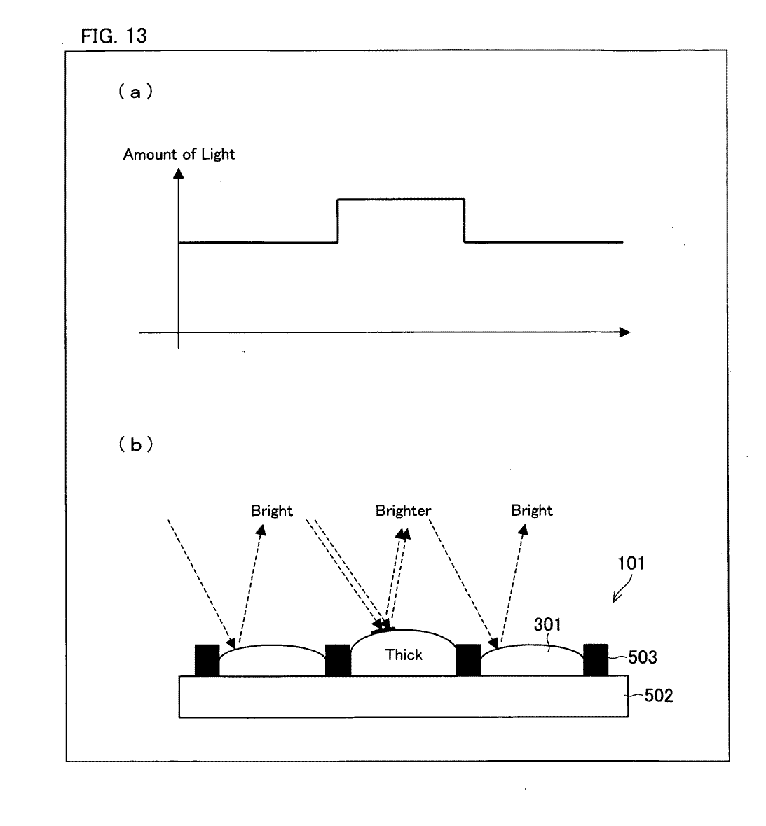

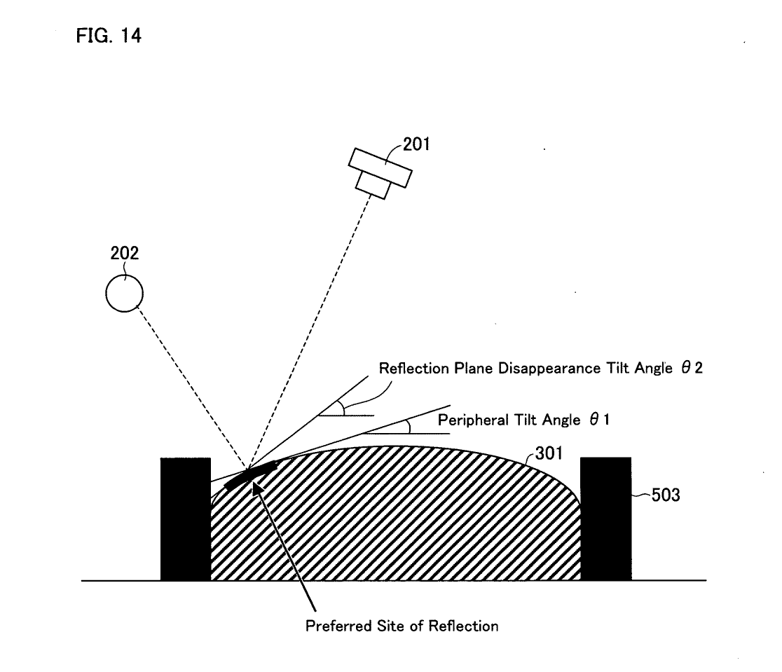

(b) of FIG. 12 and (b) of FIG. 13 are close-up cross sections of dots on the color filter substrate (inspection object) 101 shown in (a) of FIG. 4. The color filter substrate 101 includes the black matrix 503 and the dots 301 on a glass substrate 502.

(b) of FIG. 12 is a close-up cross section of a dot on the color filter substrate (inspection object) 101 which is thinner than other dots due to a certain cause.

The dot which is thinner than other dots due to a certain cause has a different reflection angle than the preceding and succeeding dots, thereby reflecting less light to the first camera (sensing means, imaging means) 201. Consequently, the reflection luminance is lower with that dot as indicated in (a) of FIG. 12.

(b) of FIG. 13 is a close-up cross section of a dot on the color filter substrate (inspection object) 101 of (a) of FIG. 4 which is thicker than other dots due to a certain cause.

The dot which is thicker than other dots due to a certain cause reflects light closer to the dot center than other dots. Consequently, the reflection luminance is higher with that dot as shown in (a) of FIG. 13.

The tilt angle is almost horizontal near the center of the dot. The amount of light reflected near the center of the dot is not easily affected by a change in deviation in thickness. In contrast, the tilt angle is relatively large near the periphery of the dot. The amount of light reflected near the periphery of the dot is easily affected by a change in deviation in thickness. The dots 401 to 403 have progressively decreasing reflection planes. In other words, for these particular dots, the amount of reflected light is easily affected by a change in deviation in thickness. Also for these dots, the light reflected near the periphery of the dots is received by the second camera 103 or the first camera (sensing means, imaging means) 201. Therefore, a change in deviation in thickness produces a greater change in the amount of reflected light for the dots 401 to 403 than for the other dots.

Under these circumstances, when the deviation in thickness is negative (the deviation in thickness is smaller then with other, normal dots, that is, the film is thinner) (FIG. 12), if the position of the light source is controlled to capture images with two conditions A and B being satisfied, the deviation in thickness can be detected as a dark line:

Conditions A: Light is reflected off the periphery of other, normal dots.

Conditions B: Less light is reflected off the dot with a negative deviation in thickness because of a smaller tilt angle. Meanwhile, when the deviation in thickness is positive (the deviation in thickness is larger than other, normal dots, that is, the film is thicker) (FIG. 13), if the position of the light source is controlled to capture images with two conditions C and D being satisfied, the deviation in thickness can be detected as a bright line:

Conditions C: Light is reflected off the periphery of other, normal dots.

Conditions D: More light is reflected off the dot with a positive deviation in thickness because of greater tilt angle and the reflection which takes place closer to the dot center than other dots.

The dot 402 positioned between the dots 401 and 403 is the middle one of the three dots which shows a maximum change in the amount of reflected light. Therefore, a deviation in thickness of that dot produces a greater difference in luminosity than any other dot. In other words, the dot 402 is affected most by a change in reflected light. Therefore, most preferably, a light projecting position is determined so as to maximize the change in the amount of the light reflected off the dot 402, and the first light source (illumination means) 202 is moved to the position because under these circumstances, conditions A to D are met, and irregularities are precisely inspected.

However, it is impossible to directly detect a light projecting position so as to maximize the change in the amount of reflected light for the following reasons. The change in the amount of reflected light is very small. As shown in (b) of FIG. 4, the amount of light reflected off the color filter surface is always changing. A point where the derivative assumes the largest value is only obtainable with large measurement error.

Accordingly, the method of determining the position of the illumination means in accordance with the present invention detects the state of the dot 401 and the state of the dot 403 and indirectly determines the state of the dot 402. First, a method will be described of determining the position of the inflection point (feature point) by obtaining, based on the position determining images, the distance between a regular reflection position on the film of the color filter substrate (inspection object) 101 where the light projected by the second light source 102 undergoes regular reflection and an inflection point (feature point) of the reflection luminance indicative of the state of the dot 401. The method makes it possible to determine the position indicative of the state of the dot 401.

It is preferable in the present invention to obtain an inflection point (feature point) based on a particular mound, like the dot 401, where the reflection luminance starts to decrease. The position indicative of the state of the dot 401 in the present embodiment is a “position which, on the inspection object, corresponds to the feature point” in the specification. The angle of reflection of light at the position indicative of the state of the dot 401 in the present embodiment is the “angle of sensing of the reflected light in step B off a position which, on the inspection object, corresponds to the feature point” in the specification. The angle of projection of light to the position indicative of the state of the dot 401 in the present embodiment is the “angle of projection of the light in step A to a position which, on the inspection object, corresponds to the feature point” in the specification.

The “feature point” is a synonym of the inflection point of the reflection luminance and refers to a point where a special change occurs to the amount of change of reflected light. A special change occurs to the amount of change of reflected light presumably because the feature point (for example, the position indicative of the state of the dot 401) is where the reflection plane starts to be formed closer to the black matrix which provides a dot-to-dot interface.

The “data on the distribution of the reflected light” in the specification is the image data obtained by projecting light onto the inspection object 101 and capturing reflected light.

In the present embodiment, the inflection point in the data obtained by one-dimensional projection of the data on the distribution of the reflected light (hereinafter, simply the “inflection point”) is detected as the feature point. The black matrix is indicated, for example, by dot-to-dot interfaces in (b) of FIG. 4.

The position of the inflection point (feature point) is obtained by, for example, by first differentiation of the luminosity distribution data obtained by one-dimensional projection of the position determining images (hereinafter, the “projection data”) and further second differentiation of the slope of the luminosity distribution obtained by the first differentiation. The direction of the one-dimensional projection is parallel to the direction in which a linear irregularity has occurred: for example, the linear irregularity direction 303 shown in (b) of FIG. 3. The data obtained by the one-dimensional project of the data on the distribution of the reflected light is smoothed to remove small fluctuations.

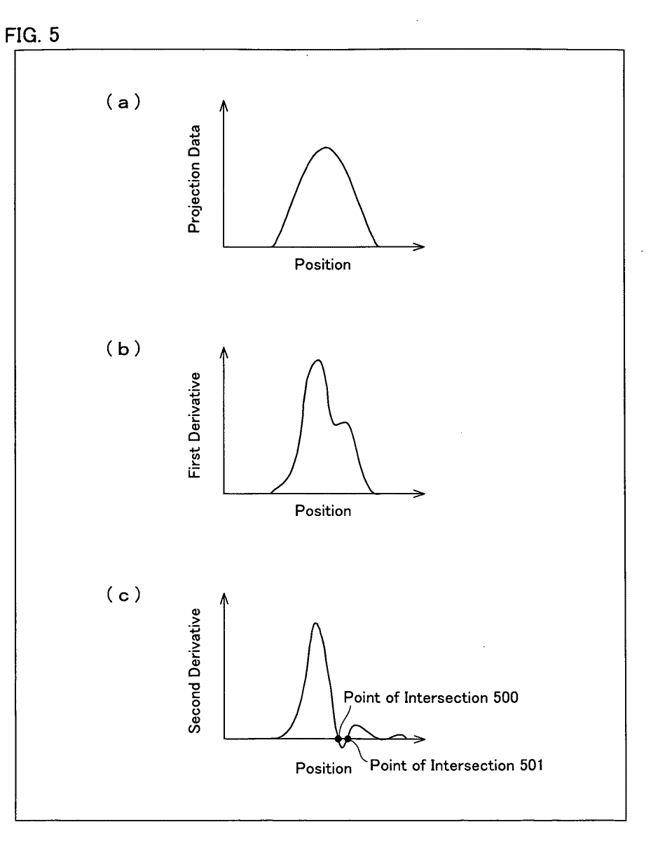

FIG. 5 is graphs representing results of detection of an inflection point (feature point) from projection data by mathematical differentiation. (a) of FIG. 5 represents projection data; (b) of FIG. 5 results of calculation of the slope of the luminosity distribution by first differentiation of the projection data; and (c) of FIG. 5 results of detection of an inflection point (feature point) by further second differentiation of the slope of the luminosity distribution. (c) of FIG. 5 indicates that the second derivative equals 0 twice at points of intersection 500 and 501. Of these tow, the point of intersection 501 where the graph for the projection data is convex up corresponds to the inflection point (feature point) that should be obtained. This inflection point (feature point) represents the state of the dot 401.

Instead of obtaining a point at which the second derivative equals 0, a point may be obtained at which the reproducible first derivative has a minimum moving standard deviation. A further alternative is to roughly detect a point at which the second derivative equals 0 and detect a point at which the first derivative has a minimum moving standard deviation in a two-dot-cycle range stretching over the point at which the second derivative equals 0. A dot cycle is the distance from a side of the black matrix enclosing a dot to another side of the black matrix facing that side.

The positions of the inflection point (feature point) thus obtained can be determined by obtaining the distance between the regular reflection position where light undergoes regular reflection and the inflection point (feature point). The regular reflection position is where luminance has a highest value and readily obtainable with conventional, publicly known methods. The regular reflection position can be determined from a captured image, for example, by obtaining a point with a highest brightness (luminance) or by identifying the light source by discrimination analysis or like binarization and subsequently determining its position center as regular reflection. The distance between the regular reflection position and the inflection point (feature point) can be determined by obtaining a coordinate distance between the two points on the captured image. The coordinate distance can be calculated from the two points on the captured image using the resolution of the image.

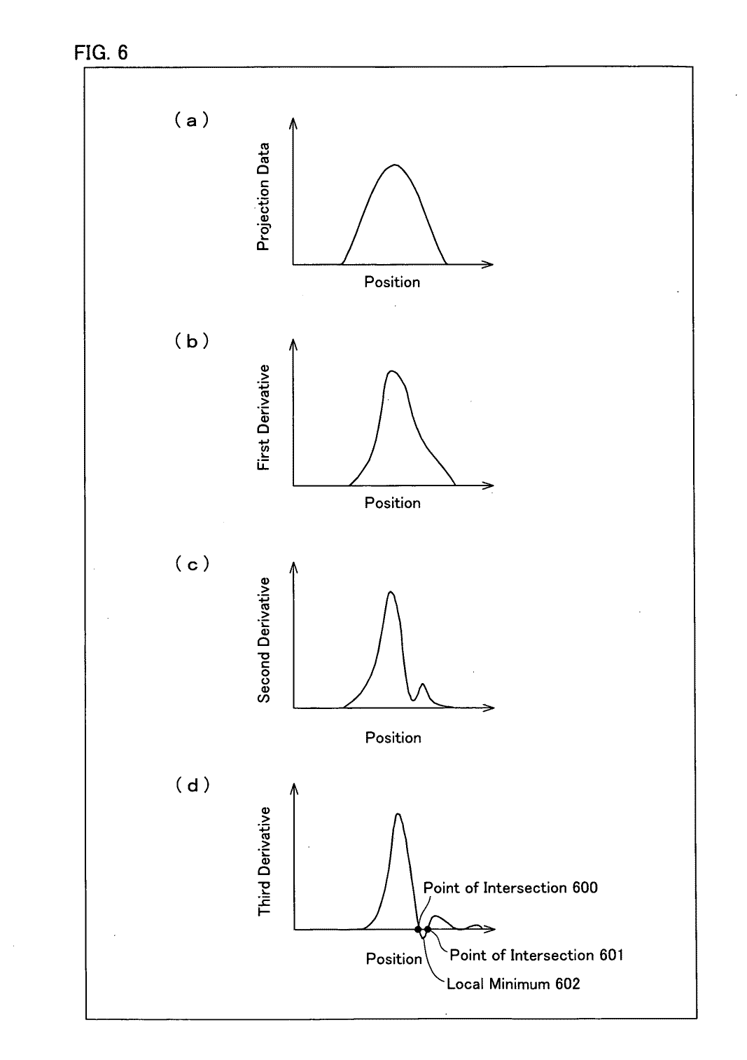

The second derivative does not equal 0 under some conditions, depending on optical conditions and the state of the inspection object. FIG. 6 is graphs representing results of detection of inflection point (feature point) from projection data under the condition that the second derivative does not equal 0. (a) of FIG. 6 represents projection data; (b) of FIG. 6 results of calculation of the slope of the luminosity distribution by first differentiation of the projection data; (c) of FIG. 6 results of further second differentiation of the slope of the luminosity distribution; and (d) of FIG. 6 results of third differentiation of the second derivative.

A point of intersection 601 at which the third derivative equals 0 and the graph for the projection data is convex down is obtained as an inflection point, as indicated in (d) of FIG. 6, by third differentiation of the second derivative. Instead of obtaining a point at which the third derivative equals 0, a point may be obtained at which the reproducible second derivative has a minimum moving standard deviation. A further alternative is to roughly detect a point at which the third derivative equals 0 and detect a point at which the second derivative has a minimum moving standard deviation in a two-dot-cycle range stretching over that point.

After determining the position of an inflection point (feature point) in this manner, a distance between the regular reflection position and a reflection plane disappearance position is obtained. The reflection plane disappearance position is a position on the film on the color filter substrate (inspection object) 101 at which the reflection luminance equals 0 and which is next to the position where non-zero luminance is observed. The reflection plane disappearance position is a position indicative of the state of the dot 403.

The reflection plane disappearance position is directly detectable by, for example, measuring the dot surface with a step-height meter or like precision measuring instrument and obtaining the surface tilt angle, to identify a position where the amount of reflected light is zero. The direct detection is also possible by, for example, obtaining luminance at a position where no reflected light is coming at all, for example, at a dot located right to the dot 403 in (b) of FIG. 4, and identifying a dot having the same luminance (for example, the dot 403 in (b) of FIG. 4).

It may be difficult to directly detect the reflection plane disappearance position, depending on the shape of the color filter substrate (inspection object) 101. When it is, the reflection plane disappearance position can be detected by a comparison of the inspection object with a reference sample which has a definite reflection plane disappearance position.

For example, the reflection plane disappearance position of an inspection object is indirectly obtainable by imaging a reference sample that is circular rather than elliptical and utilizing a proportional relationship from the position of an inflection point and the reflection plane disappearance position on the reference sample and the position of an inflection point on the inspection object.

A reflection plane disappearance angle is obtainable from the reflection plane disappearance position obtained in this manner. In this specification, a “reflection plane disappearance angle” is the angle of a surface mound located at a position on the inspection object, the position corresponding to a position where no light is observable according to the distribution of the reflected light when light is projected onto the inspection object to detect distribution of the light reflected off the inspection object. In the present embodiment, the reflection plane disappearance angle is obtainable from the angle of the first camera (sensing means, imaging means) 201 at which the reflected light is completely blocked by, for example, the black matrix on the surface mound when the positions of the color filter substrate (inspection object) 101 and the first light source (project means) 202 are determined.

The reference sample that is circular rather than elliptical is, for example, a sample on which a shape is precisely identified. Examples include circular metal or quartz patterns and convex/concave patterns of lenses and Braille. The present embodiment deals with color filters as the inspection object. The sample may be made of a different material from the color filter (that is, metal or quartz) because measurement only utilizes reflected light.

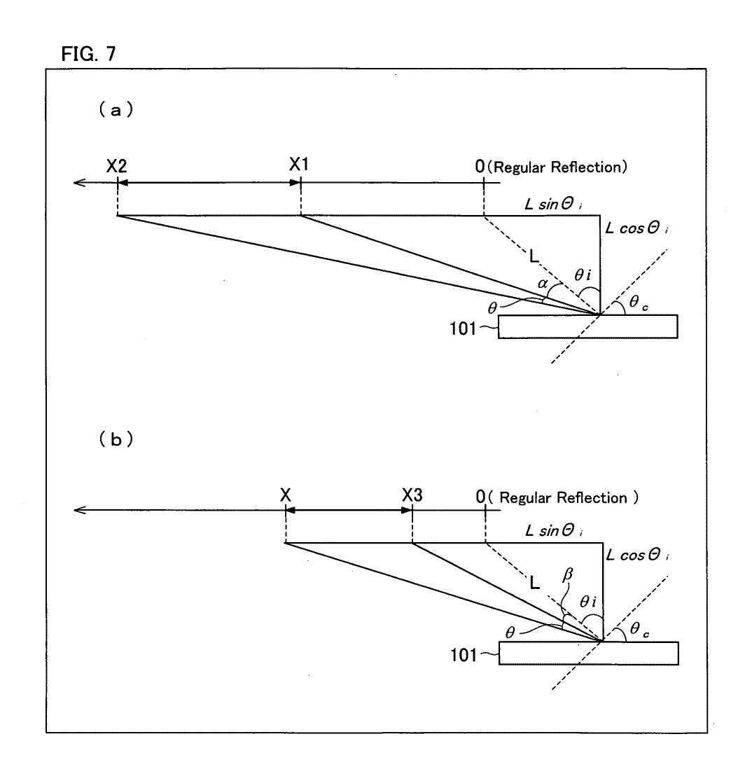

FIG. 7 illustrates a method of obtaining the reflection plane disappearance position on the color filter substrate (inspection object) 101 by using the reference sample. Designating the position of the second light source 102 where regular reflection is observed on the second camera 103 as the origin (zero point) and letting X1 be the position of the second light source 102 where an inflection point is observable with the reference sample, X2 be the position of the second light source 102 (reflection plane disappearance position) where disappearance of a reflection plane is observable with the reference sample, X3 be the position of the second light source 102 where an inflection point is observable with the color filter substrate (inspection object) 101, and X be the position of the second light source 102 (reflection plane disappearance position) where disappearance of a reflection plane is observable with the color filter substrate (inspection object) 101, X is given by equation 1.

In FIG. 7, L indicates the distance from the regular reflection position where the light projected by the second light source 102 undergoes regular reflection to the second light source 102; θ indicates the angle between the position of the dot 401 and the position of the dot 403 in (b) of FIG. 4; and θi indicates the angle of the line connecting the position of the second light source 102 where regular reflection is observed to the regular reflection position with respect to the normal to the color filter substrate (inspection object) 101. L, θ, and θi are constants dictated by optical design values.

$$\begin{matrix}[ Eq . 3 ] & \\ X = X 3 + L \cdot cos {θ}_{i} \cdot [ \frac{tan θ + tan ( {θ}_{i} + β )}{1 - tan θ \cdot tan ( {θ}_{i} + β )} - tan ( {θ}_{i} + β ) ] \\ where \\ tan ( {θ}_{i} + β ) = \frac{X 3 + L \cdot sin {θ}_{i}}{L \cdot cos {θ}_{i}} \\ tan θ = \frac{\frac{X 2 - X 1}{L \cdot cos {θ}_{i}}}{1 + \frac{( X 2 + L \cdot sin {θ}_{i} ) ( X 1 + L \cdot sin {θ}_{i} )}{{( L \cdot cos {θ}_{i} )}^{2}}} & ( Eq . 1 )\end{matrix}$$

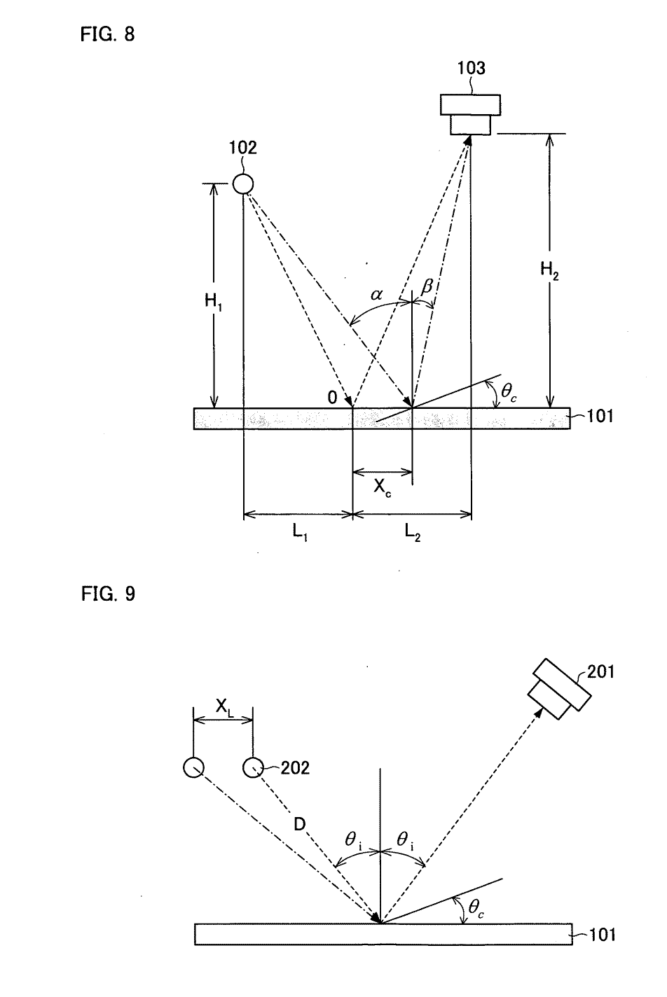

The position of the state of the dot 402 is obtained by obtaining a halfway point between the position of X3 obtained by equation 1 and the position of X (hereinafter, the “center position”). Once the center position is determined, the tilt angle of the film on the color filter substrate (inspection object) 101 off the substrate plane at the center position, that is, the tilt angle of the dot at the center position (tilt angle of the dot 402 in the above example) is obtainable. FIG. 8 is an illustration of a process of converting data on the center position to the tilt angle of the dot at the center position.

In FIG. 8, θc indicates the tilt angle of the dot 402; Xc indicates the distance from the regular reflection position to the center position of the dot 402; H1 indicates the height of the second light source 102 above the color filter substrate (inspection object) 101; H2 indicates the height of the second camera 103 above the color filter substrate (inspection object) 101; L1 indicates the distance from the regular reflection position to the point of intersection of the color filter substrate (inspection object) 101 and the normal to the color filter substrate (inspection object) 101 passing through the second light source 102; and L2 indicates the distance from the regular reflection position to the point of intersection of the color filter substrate (inspection object) 101 and the normal to the color filter substrate (inspection object) 101 passing through the second camera 103.

α indicates the angle between the normal to the plane of the color filter substrate (inspection object) 101 passing through the center position and the ray of light emitted by the second light source 102 and incident at the center position. β indicates the angle between that normal and the ray of light reflected at the center position toward the second camera 103.

H1, H2, L1, and L2 are optical design values. Therefore, once Xc is obtained, the tilt angle θc of the dot 402 can be calculated by equation 2 (in this case, θc is greater than the peripheral tilt angle. It is an angle between the peripheral tilt angle and the reflection plane disappearance angle and an exactly intermediate angle between the peripheral tilt angle and the reflection plane disappearance angle). Since θc only needs to be greater than the peripheral tilt angle and be an angle between the peripheral tilt angle and the reflection plane disappearance angle, it is not necessary to obtain the exactly intermediate angle θc between the peripheral tilt angle and the reflection plane disappearance angle. θc, however, is preferably an exactly intermediate angle between the peripheral tilt angle and the reflection plane disappearance angle for a greater change in the amount of reflected light.

The peripheral tilt angle can also be obtained by equation 2. The peripheral tilt angle in the present embodiment is the angle of a part of the mound surface of the dot 401 where reflection occurs. Note however that since light is reflected at different parts of the dot 402 depending on the positions of the second camera 103 and the second light source 102, the peripheral tilt angle is more accurately the angle of an incident-light-reflecting part of the dot 401 corresponding to the feature point when the positions of the second camera 103 and the second light source 102 are determined.

The peripheral tilt angle can be obtained by substituting the distance from the regular reflection position to the feature point for Xc. In this case, a in equation 2 is the angle, in FIG. 8, between the normal to the plane of the color filter substrate (inspection object) 101 passing through the feature point and the ray of light emitted by the second light source 102 and incident at the feature point. α is also the angle of projection of the light in step A to a position which, on the inspection object, corresponds to the feature point. β in equation 2 is the angle, in FIG. 8, between the normal to the plane of the color filter substrate (inspection object) 101 passing through the feature point and the ray of light reflected at the feature point toward the second camera 103. β is also the angle of sensing of the reflected light in step B at a position on the inspection object corresponding to the feature point. Since the positions of the second camera 103 and the second light source 102 do not change, H1, H2, L1, and L2 have the same values as in the foregoing case where the tilt angle θc of the dot 402 is obtained by equation 2.

The distance between the regular reflection position and the feature point can be determined by obtaining a coordinate distance between the two points on the captured image in the same manner as above. The coordinate distance can be calculated from the two points on the captured image using the resolution of the image.

The tilt angle θc of the dot 402 is, as mentioned earlier, greater than the peripheral tilt angle, is an angle between the peripheral tilt angle and the reflection plane disappearance angle and preferably an exactly intermediate angle between the peripheral tilt angle and the reflection plane disappearance angle. Therefore, the tilt angle θc of the dot 402 is directly obtainable using equation 2 as above and alternatively, indirectly obtainable form calculation using the values of the peripheral tilt angle and the reflection plane disappearance angle.

$$\begin{matrix}[ Eq . 4 ] & \\ {θ}_{c} = \frac{α - β}{2} \\ where \\ α = {tan}^{- 1} ( \frac{{L}_{1} + {X}_{c}}{{H}_{1}} ) \\ β = {tan}^{- 1} ( \frac{{L}_{2} - {X}_{c}}{{H}_{2}} ) & ( Eq . 2 )\end{matrix}$$

Once the tilt angle θc of the dot 402 is obtained, the position XL of a light source from which light is projected to achieve that tilt angle is obtained. FIG. 9 is an illustration of a process of obtaining the position XL of a light source from the tilt angle θc of a dot. In FIG. 9, D indicates the distance from the first light source (project means) 202 to the regular reflection position where the light projected by the first light source (project means) 202 undergoes regular reflection. The position XL of a light source can be calculated by substituting θc to equation 3 because θi and D are optical design values and constants.

### [Eq. 5]

X_{L}=tan(2θ_{c}+θᵢ)·D cos θᵢ−D sin θᵢ (Eq. 3)

Once XL is obtained by equation 3, as illustrated in FIG. 9, an optimal light source position can be determined because a position off the regular reflection position by as much as XL in a direction parallel to the plane of the color filter substrate (inspection object) 101 is the light-projecting position where the light reflected off the dot 402 shows a maximum change in amount with respect to deviation in thickness. In other words, it would be sufficient if the first light source (project means) 202 in the inspection device 200 is moved to the position. In so doing, since only the first light source (illumination means) 202 needs to be moved by a distance XL, the first camera (sensing means, imaging means) 201 may be fixed.

In this manner, an irregularity inspection image with which the reflected light shows a maximum change in amount with respect to deviation in thickness of the dot 402 is obtained by moving the first light source (illumination means) 202 to the positioned by the calibration device (calibration means, feature point detection means, tilt angle calculation means) 100 from the position determining images, projecting light from the position onto the color filter substrate (inspection object) 101, and receiving reflected light on the first camera (sensing means, imaging means) 201. Then, the irregularity judging device (inspection means) 203 in the inspection device 200 determines presence/absence of irregularities on the color filter substrate (inspection object) 101 from the irregularity inspection image.

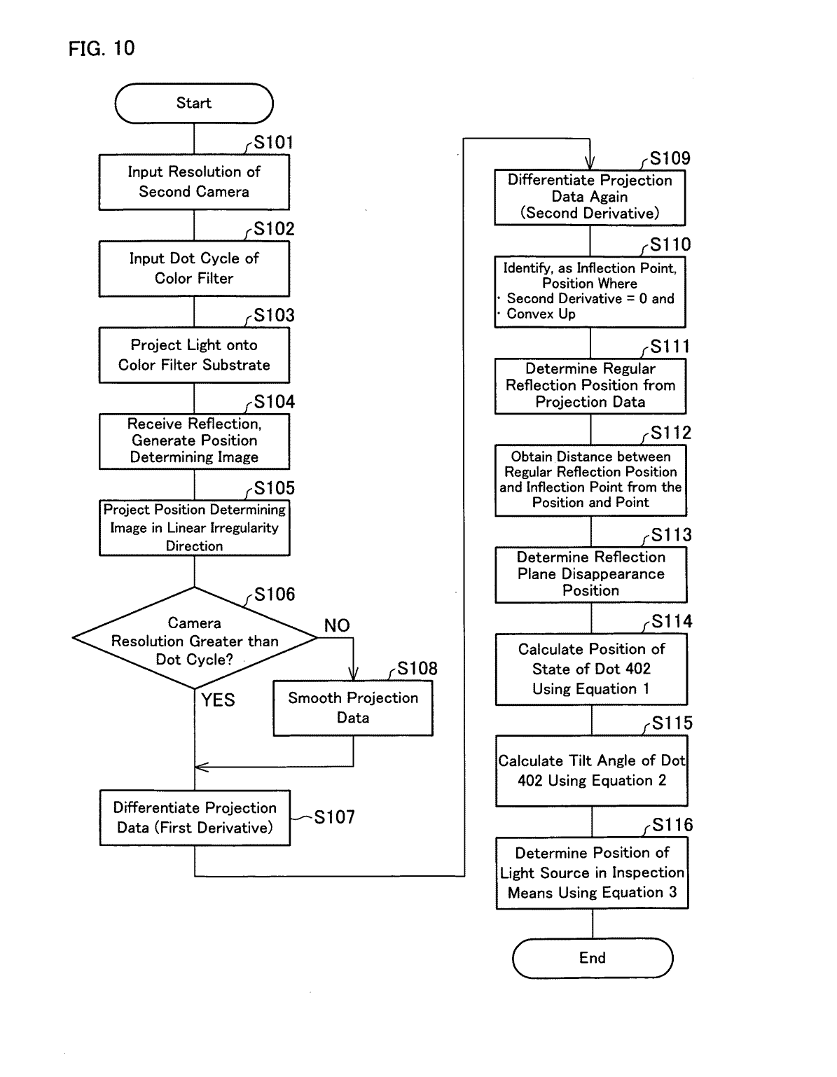

The following will describe a specific method of determining a light source position in reference to FIG. 10. FIG. 10 is a flow chart depicting a method of determining the position of illumination means in accordance with the present invention.

First, the resolution of the second camera 103, that is, a physical length for one dot, is input. This step may be executed by retrieving existing settings (S101). Next, the dot cycle of the color filter substrate (inspection object) 101 corresponding to the stage moving direction 304 is substituted (S102), The second light source 102 and the second camera 103 are moved to positions where the second camera 103 can receive regular reflection of the light projected by the second light source 102 to the color filter substrate (inspection object) 101, and light is projected by the second light source 102 to the color filter substrate (inspection object) 101 (S103; first step). A position determining image is generated by receiving the reflected light on the second camera 103 (S104; second step). Projection data is obtained by projecting the position determining image in the linear irregularity direction 303 (S105). In the step, preferably, the projection data is averaged for normalization by dividing the projection data by the number of projections.

Next, the resolution and the dot cycle, of the camera, which are input in S101 and S102, are compared (S106). If the resolution of the camera is greater, the projection data is subjected to first differentiation (S107; third step). If the resolution of the camera is smaller, the projection data is smoothed (S108). The size of the smoothing is preferably at least twice the dot pitch. After the smoothing, the projection data is subjected to first differentiation (S107; third step).

The slope of the luminosity distribution obtained by the first differentiation in S107 is subjected further to second differentiation (S109; third step). A position where the second derivative equals 0 and the graph for the projection data is convex up is identified as an inflection point (S110; third step) as shown in (c) of FIG. 9. Alternatively, as mentioned earlier, the second derivative may be subjected further to third differentiation. Next, the regular reflection position is determined from the projection data (S111). The distance between the regular reflection position and the inflection point is obtained (S112; third step).

The reflection plane disappearance position is determined by substituting the obtained distance between the regular reflection position and the inflection point to equation 1 and obtaining the distance between the regular reflection position and the reflection plane disappearance position on the film on the color filter substrate (inspection object) 101 at which the reflection luminance equals 0 and which is next to the position where non-zero luminance is observed (S113; fourth step). The center position, or a halfway point between the position of the inflection point and the reflection plane disappearance position, is obtained (S114; fifth step). The reflection plane disappearance position may be directly detected without using equation 1.

Subsequently, the tilt angle of the dot at the center position (tilt angle of the dot 402 in the above example) is obtained by equation 2 based on the obtained center position (S115; sixth step). The position of the first light source (illumination means) 202 in the inspection device 200 is determined by equation 3 from the tilt angle (S116; seventh step), which concludes the process. The first light source (illumination means) 202 is moved to the light source position obtained in this manner as shown in (c) and (d) of FIG. 2. The color filter substrate (inspection object) 101 is moved beneath the first light source (illumination means) 202 to project light onto an image capture plane 206.

The first light source (illumination means) 202 is provided with a drive rail on each end to change the gap (distance) separating the end from the color filter substrate (inspection object) 101. Each drive rail is preferably adopted to allow altering the distance separating the associated end of the first light source (illumination means) 202 from the surface of the color filter substrate (inspection object) 101 along a projection-side optical axis of the light projected by the first light source (illumination means) 202, reflected by the color filter substrate (inspection object) 101, and received by the first camera (imaging means) 201.

In (c) of FIG. 2, light source stages 204, 205 are provided which are an equivalent to the drive rails. The first light source (illumination means) 202 is moved using the light source stages 204, 205. Therefore, the ends are adapted to be independently controllable to any given positions. The image capture plane 206 is imaged by the first camera (imaging means) 201 to generate an inspection image for linear irregularity inspection.

The method of inspecting for irregularities in accordance with the present invention, encompassing the method of determining the position of illumination means in accordance with the present invention, is implementable by, as mentioned earlier, determining the position of the first light source (illumination means) 202 and judging irregularities based on the inspection images.

### Embodiment 2

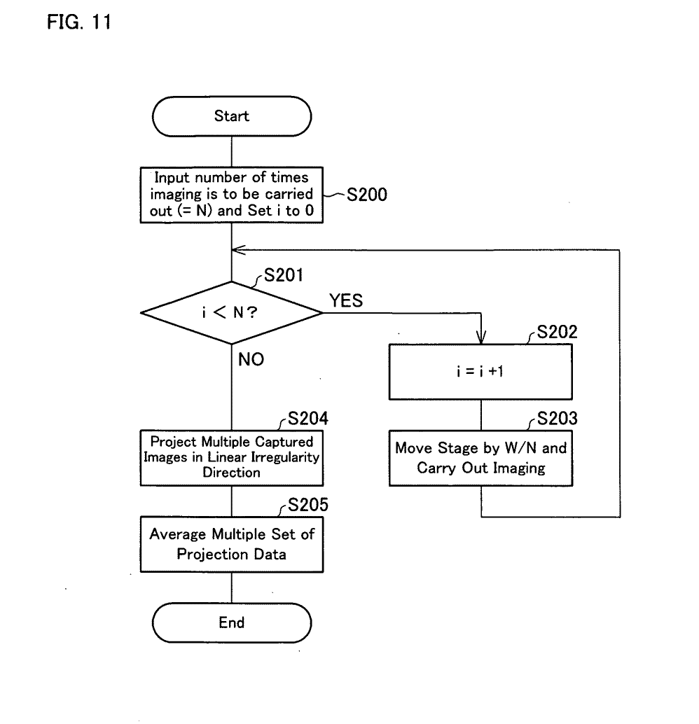

An inflection point is detected by a single imaging in embodiment 1. In present embodiment 2, an embodiment will be described which is more effective when a higher level of reproducibility and reliability is required. As illustrated in FIG. 4, the projection data exists only at the dot cycle. To achieve further reproducibility and reliability with the method of determining the position of illumination means in accordance with the present invention, data is preferably obtained in the dot cycle. Accordingly, in the present example, the stage 104 is moved in S103 for interpolation with data in the dot cycle. FIG. 11 is a flow chart depicting a process of interpolating with data in the dot cycle.

First, the number of times imaging is to be carried out (=N) is fed to the second camera 103 to set a counter i to 0 (S200). The counter i is provided to carry out imaging an intended number of times by managing the number of times imaging is to be carried out.

Next, it is determined if the counter i reads less than N (S201). If the counter i reads less than N, the process proceeds to S202; if the counter i reads greater than N, the process proceeds to S204. The reading is incremented by 1 in S202. In S203, the stage 104 is moved as much as the dot cycle W obtained in S102 divided by the number of times imaging is to be carried out (=N) for that number of times of imaging. The process then returns to S201.

It is only part of the dot that reflects light. Therefore, if the second camera 103 used in calibration has a lower resolution than the dot cycle, no reflected light may be captured depending in some sampling patterns, producing discrete data and thereby leading to poor reproducibility. To reduce sampling error, the stage 104 is repeatedly moved by a miniscule amount and imaged in S203 for averaging the data in the dot cycle. The scheme interpolates discrete data, reduces error, and achieves improved reproducibility.

The N images obtained are all projected in the linear irregularity direction 303 in S204. The N pieces of projection data obtained in the preceding step are averaged in S205. S201 to S205 are carried out after S110 in FIG. 10 to obtain the difference between the point of intersection 601 and the local minimum 602 in (d) of FIG. 6 as a correction value for addition to the calculated inflection point. After that, S111 and succeeding steps are carried out similarly to embodiment 1.

If the second derivative equals 0 as in, for example, (c) of FIG. 5, the difference between the point of intersection 501 and the local minimum is obtained as a correction value for addition to the calculated inflection point.

### Embodiment 3

In embodiments 1, 2, an optimal position of the first light source (illumination means) 202 is uniquely determined Alternatively, the relative positions of the first light source (illumination means) 202, the inspection object 101, and the first camera (sensing means, imaging means) 201 may be determined so that the light projected by the first light source (illumination means) 202 is reflected off a part of the inspection object 101 which has a greater angle than the peripheral tilt angle of the surface mound and received the first camera (sensing means, imaging means) 201.

FIG. 14 illustrates the relative positions. Here, the relative positions of the first light source (illumination means) 202, the color filter substrate (inspection object) 101, and the first camera (sensing means, imaging means) 201 are determined so that the light projected by the first light source (illumination means) 202 is reflected off the part, on the surface of the dot 301 on the color filter substrate (inspection object) 101, which has an angle greater than the peripheral tilt angle θ1 and the reflected light is incident to the first camera (sensing means, imaging means) 201.

The light reflected off the part which has an angle greater than a reflection plane disappearance tilt angle θ2 is blocked by the black matrix 503. Therefore, the relative positions need to be adjusted so that the light reflected off the part which has an angle greater than or equal to the peripheral tilt angle and less than or equal to the reflection plane disappearance tilt angle θ2 (“Preferred Reflection Part” shown in FIG. 14) is incident to the first camera (sensing means, imaging means) 201.

For better measurement precision, the first camera (sensing means) is especially preferably disposed on a line which is an extension of the path followed by the reflection of the light projected by the first light source (illumination means) 202 off the part which has an exactly intermediate angle, θ1+θ2/2, of the peripheral tilt angle θ1 and the reflection plane disappearance tilt angle θ2.

Optimal relative positions can be determined for the first light source (illumination means) 202, the color filter substrate (inspection object) 101, and the first camera (sensing means, imaging means) 201 by satisfying these conditions on the relative positions.

Instead of moving the first light source (illumination means) 202 to its optimal position as in embodiments 1, 2, for example, either one of the stage or the first camera (sensing means, imaging means) 201 may be moved. A further alternative is to move any two or all of the first light source (illumination means) 202, the color filter substrate (inspection object) 101, and the first camera (sensing means, imaging means) 201.

Although the feature point is determined based on an inflection point in the graph plotted from the projection data in embodiments 1, 2, the feature point may be determined not based on an inflection point, but based on a position where there occurs a unique change.

### Embodiment 4

No distinction is made on the colors of the dots 301 on the color filter substrate (inspection object) 101 in embodiments 1 to 3. Separate thickness deviation inspection may be carried out for each color.

When no distinguish is made between the three colors, the optimal relative positions of the first light source (illumination means) 202, the color filter substrate (inspection object) 101, and the first camera (sensing means, imaging means) 201 which well fit the individual colors cannot be determined because the positions of the light sources are obtained from the projection data which is averaged out on the colors.

Some types of the color filter substrate (inspection object) 101 have a slightly different film thickness, hence a different film tilt angle near the black matrix, for a different color due to ink material and other causes. Therefore, the optimal positions of the first light source (illumination means) 202, the color filter substrate (inspection object) 101, and the first camera (sensing means, imaging means) 201 could change from one color to the other.

In a case like this, inspection precision can be further improved by setting up the first light source (illumination means) 202, the color filter substrate (inspection object) 101, and the first camera (sensing means, imaging means) 201 at optimal positions for each color and inspecting the deviation in thickness for each color.

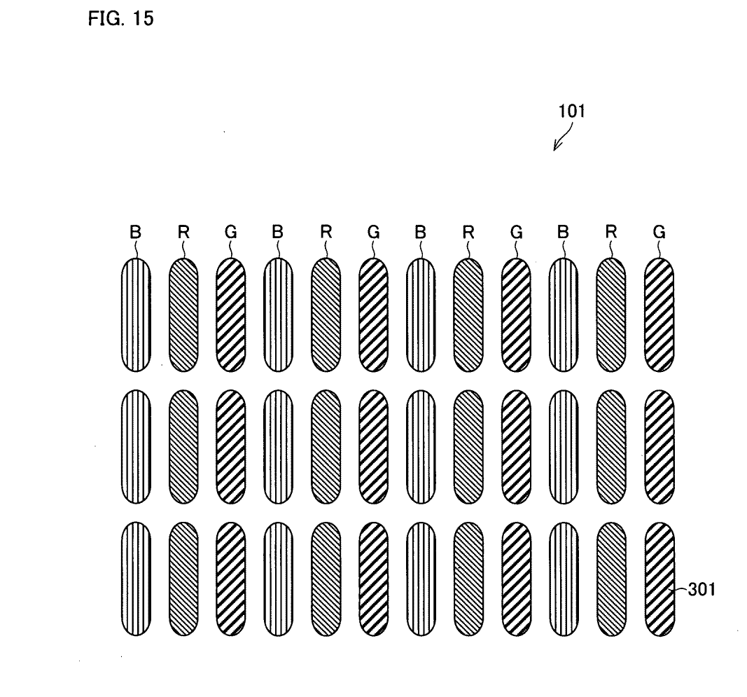

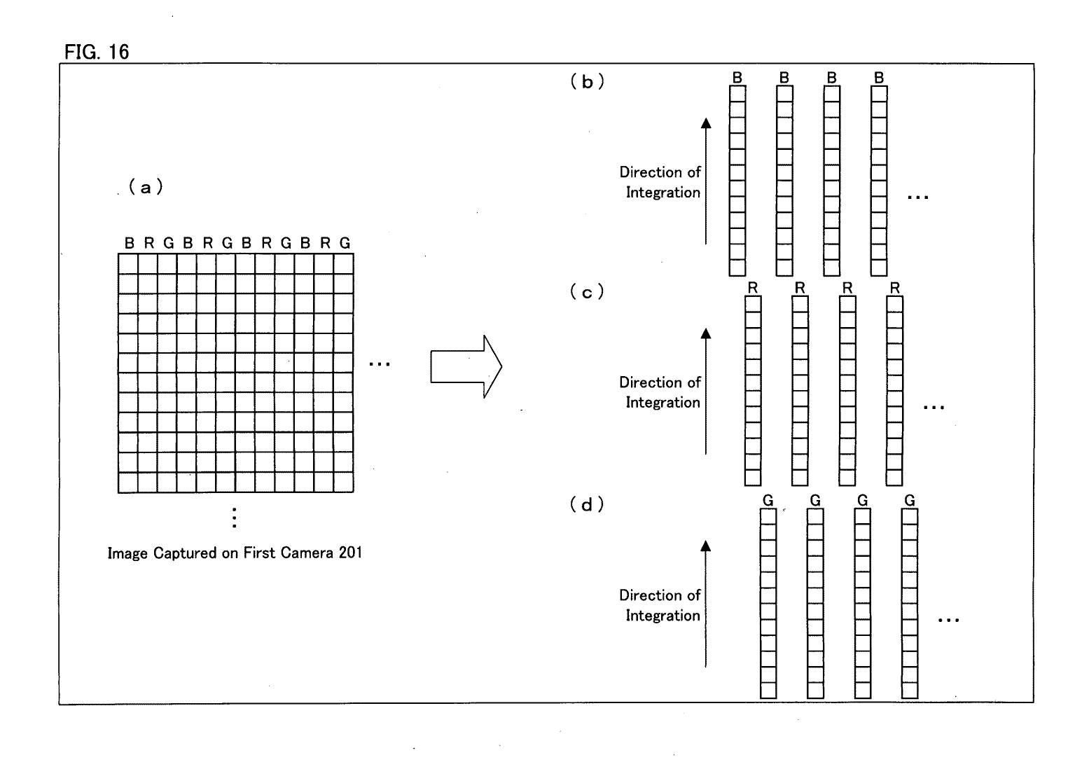

An image of the color filter substrate (inspection object) 101 shown in FIG. 15 captured on the first camera (sensing means, imaging means) 201 is illustrated in (a) of FIG. 16. The image data does not distinguish between the three colors, red, blue, and green. The data, separated for each color, is illustrated in (b), (c), and (d) of FIG. 16. (b) of FIG. 16 shows extracted blue color data; (c) of FIG. 16 extracted red color data; and (d) of FIG. 16 extracted green color data.

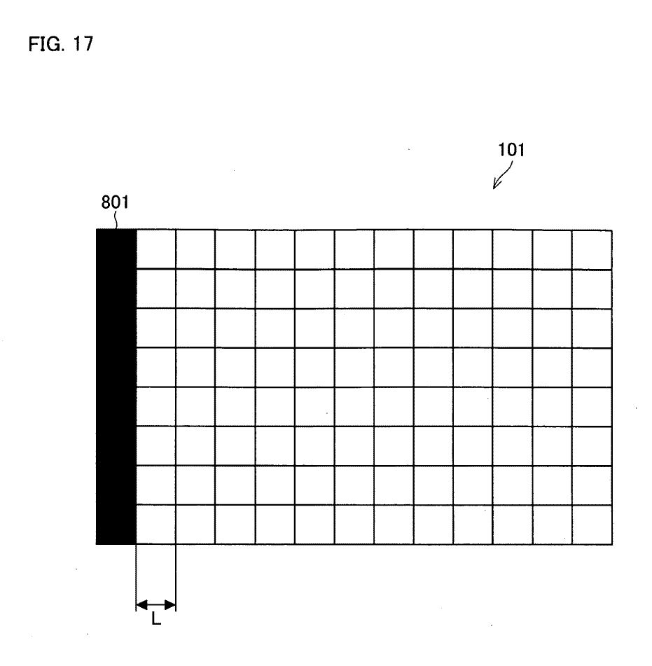

The color of a captured pixel column is identified, as illustrated in FIG. 17, by including the edge 801 of color filter substrate (inspection object) 101 in the captured image. Specifically, the dot pitch of the color filter substrate (inspection object) 101 is already known. One can identify the color of the dot off which light is reflected and captured by measuring a distance L from the edge 801 to each pixel in the imaging data.

Alternatively, when the first camera (sensing means, imaging means) 201 is a color-sensitive camera, one can identify the color of the dot on the color filter substrate (inspection object) 101 off which light is reflected and captured from the color of the captured image.

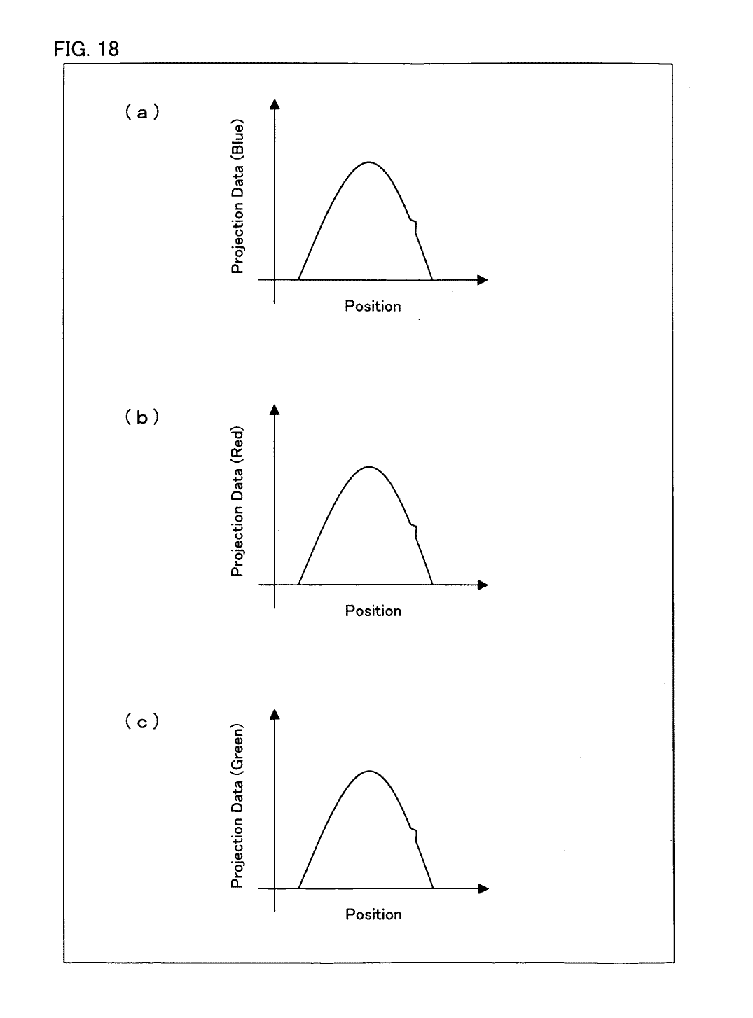

Next, the data extracted for each color is integrated along a linear irregularity direction for each color, and the distribution of the reflected light is obtained similarly to embodiment 1. Here, the three graphs shown in FIG. 18 are drawn. The graph (a) of FIG. 18 represents a result of integration of only the blue component; the graph (b) of FIG. 18 a result of integration of only the red component; and the graph (c) of FIG. 18 a result of integration of only the green component.

From these graphs, the tilt angle near the periphery of a dot on the color filter substrate (inspection object) 101 for each color is obtained. The optimal relative positions of the first light source (illumination means) 202, the color filter (inspection object) 101, and the first camera (sensing means, imaging means) 201 can be determined for each color.

First, an inflection point (feature point) and a reflection disappearance position of the reflection luminance are obtained based on the imaging data for blue dots similarly to embodiment 1 to determine an optimal light source position for blue dots and inspect for a linear irregularity.

Next, an optimal light source position for red dots and another for green dots are obtained to inspect for deviation in thickness for each color by similar procedures.

The procedures reduce effect of deviation in thickness caused by different ink materials and other reasons specific to each color, thereby further improving inspection precision. The distribution of the reflected light of the color filter substrate (inspection object) 101 is, in the present embodiment, sensed a total of three times, once for each color. The inflection point (feature point) and the reflection disappearance position of the reflection luminance are obtained based on specific surface mounds of each color. Accordingly, the relative positions of the optimal illumination means, the inspection object, and the sensing means can be determined for surface mounds of each color, thereby improving inspection precision, even if the thickness differs slightly from color to color and the inflection point (feature point) differs from color to color.

The inspection is repeated a total of three times, once for each of the three colors, in the present embodiment. The detection may alternatively be done for one or two of the colors, for example, when it is known that thickness deviations is likely to occur to dots of a particular color due to a certain cause.

The light source position is determined separately for each color in the present embodiment. The process may be exploited to characterize the film on the color filter substrate (inspection object) for each color. For example, it is possible to obtain information that the red dots have a smaller or greater thickness than the dots of the other colors due to ink material.

### Embodiment 5

In embodiment 4, the imaging data is integrated separately for each color. The image captured on the first camera (sensing means, imaging means) 201 may contain two or more dots on the color filter substrate (inspection object) 101. When that is the case, those pixels are excluded from the calculation (not evaluated in the process) to further improve inspection precision.

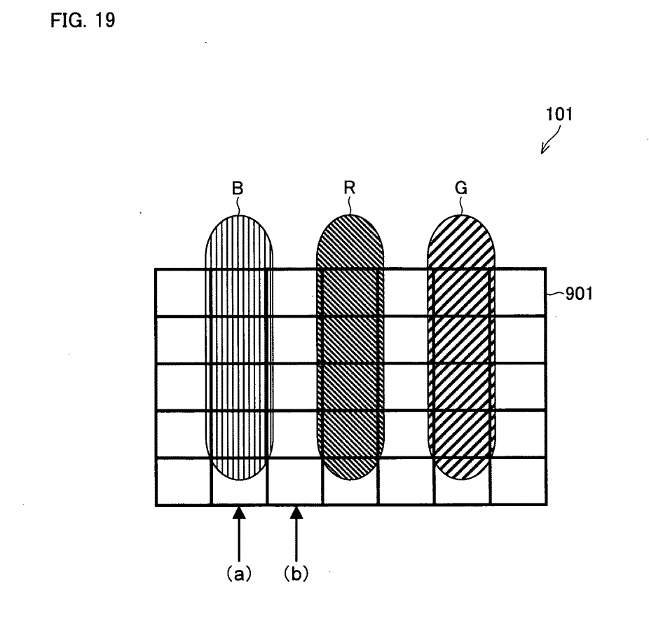

FIG. 19 is an illustration of an image capturing pixel area 901 on the first camera (sensing means, imaging means) 201 and dots on the color filter substrate (inspection object). Here, each subarea in the image capturing pixel area 901 of the first camera (sensing means, imaging means) 201 corresponds to an image capturing area for one pixel in the captured image.

As an example, the captured pixel column indicated by (a) in FIG. 19 contains a blue dot column on the color filter substrate (inspection object) 101. Meanwhile, the captured pixel column indicated by (b) in FIG. 19 contains a stretch of non-dot area located exactly halfway between a blue dot column and a red dot column. When the inflection point (feature point) is to be obtained based on the data on the distribution of the reflected light for each color, if the inspection involves the data on the distribution of the reflected light about halfway between two surface mounds of different colors like the captured pixel column (b) in FIG. 19, it could lead to a fall in inspection precision. Accordingly, the inspection precision can be further improved by excluding the captured pixel column (b) in FIG. 19 from the calculation (not evaluated in the process). In other words, the inspection precision can be further improved by obtaining the inflection point (feature point) based on data other than the data on the distribution of the reflected light about halfway between two surface mounds of different colors.

The present invention is not limited to the description of the embodiments above, but may be altered by a skilled person within the scope of the claims. An embodiment based on a proper combination of technical means disclosed in different embodiments is encompassed in the technical scope of the present invention.

The embodiments of the method and device for inspecting an inspection object having surface mounds of the present invention, as detailed above, includes the following technical means.

A method of determining a position of illumination means in accordance with the present invention is, to address the problems, is implemented by an irregularity inspection device including illumination means for projecting light illuminating a linear part of a film surface and imaging means for receiving light reflected off the film surface onto which light is projected, in order to detect, on an inspection object including the film having very small, orderly arranged surface mounds, an irregularity caused by deviation in thickness in a specific direction of a surface mound from other surface mounds, the method including: the first step of projecting light onto the film on the inspection object; the second step of receiving the light reflected off the film on the inspection object to generate a position determining image; the third step of obtaining, based on the position determining image, a distance between an inflection point of luminance of the reflected light and a regular reflection position at which the projected light undergoes regular reflection off the film on the inspection object, to determine a position of the inflection point; the fourth step of determining a distance between the regular reflection position and a reflection plane disappearance position on the film at which the luminance of the reflected light equals 0 and which is next to a position where non-zero luminance is observed; the fifth step of obtaining a center position which is a halfway point between the position of the inflection point and the reflection plane disappearance position; the sixth step of obtaining a tilt angle of the film at the center position with respect to a plane of the inspection object by equation 1,

$$\begin{matrix}[ Eq . 6 ] & \\ {θ}_{c} = \frac{α - β}{2} \\ where \\ α = {tan}^{- 1} ( \frac{{L}_{1} + {X}_{c}}{{H}_{1}} ) \\ β = {tan}^{- 1} ( \frac{{L}_{2} - {X}_{c}}{{H}_{2}} ) & ( Eq . 2 )\end{matrix}$$

α is an angle between a normal to the plane of the inspection object passing through the center position and the light projected by the illumination means incident at the center position, and β is an angle between the normal and light reflected at the center position to the imaging means; and the seventh step of determining an optimal position of the illumination means for receiving the light reflected at the center position from the tilt angle by equation 2,

### [Eq. 7]

X_{L}=tan(2θ_{c}+θᵢ)·D cos θᵢ−D sin θᵢ (Eq. 3)

Generally, irregularities of, for example, a color filter are caused by a tilt angle of a peripheral face of an irregular dot when compared with normal dots. The amount of the reflected light changes at the part having that tilt angle. To detect deviations in thickness on the order of a few tens to a few hundreds of nanometers with an irregularity inspection device, it is necessary to detect a site in the part having the tilt angle where the amount of the reflected light undergoes a large change, capture a position determining image, and determine the position of the illumination means in the irregularity inspection device based on the position determining image.

When a linear part of a film surface of an inspection object having irregularities is illuminated with the illumination means being fixed to a position in the irregularity inspection device, the sufficient reflection plane off which light is reflected to the imaging means is continuous until one of orderly arranged films. Thereafter, however, the reflection plane starts decreasing and finally disappears. In other words, the amount of reflected light shows the greatest change somewhere between a position where the reflection plane of the film starts decreasing and a position where the reflection plane disappears. Therefore, if the position of the illumination means is adjusted so as to illuminate these sites, it becomes possible to precisely inspect for irregularities.

The method of the present invention determines, based on the position determining image, the position of the inflection point, of the luminance of the reflected light, at which the reflection plane starts decreasing and the reflection plane disappearance position at which the reflection plane disappears. The method then obtains the tilt angle based on these positions. Thus, the method is capable of detecting a site where the amount of the reflected light undergoes a large change and determining the site as the position of the illumination means. The method thus cuts short the time taken to determine an optimal light source position which could vary from one inspection object to the other. The method also improves irregularity detection precision of the irregularity inspection device.

The method of determining a position of the illumination means in accordance with the present invention is preferably such that: the inflection point is obtained by subjecting to first differentiation luminosity distribution data obtained by projecting the position determining image in the specific direction for a first derivative and subjecting further to second differentiation a slope of the luminosity distribution obtained by the first differentiation for a second derivative; and the second derivative equals 0 at the inflection point.

The method invariably identifies by the second differentiation the position of the inflection point obtained by the first differentiation. The method thus further cuts short the time taken to determine the optimal light source position which could vary from one inspection object to the other. The method also further improves irregularity detection precision of the irregularity inspection device.

The method of determining a position of the illumination means in accordance with the present invention is furthermore preferably such that the inflection point is a point at which the first derivative has a minimum moving standard deviation in a two-dot-cycle range stretching over a point at which the second derivative equals 0.

The method obtains a point at which the second derivative equals 0 to roughly determine an inflection point and then obtains a point at which the first derivative has a minimum moving standard deviation in a two-dot-cycle range stretching over the roughly determined inflection point. Therefore, the position of the inflection point can be more invariably determined. The method thus further cuts short the time taken to determine the optimal light source position which could vary from one inspection object to the other. The method also further improves irregularity detection precision of the irregularity inspection device.

The method of determining a position of the illumination means in accordance with the present invention is preferably such that: the inflection point is obtained by subjecting to first differentiation luminosity distribution data obtained by projecting the position determining image in the specific direction, subjecting to second differentiation a slope of the luminosity distribution obtained by the first differentiation for a second derivative, and subjecting the second derivative to third differentiation for a third derivative; and the third derivative equals 0 at the inflection point.

The second derivative does not equal 0 under some conditions, depending on optical conditions and the state of the inspection object. The method is capable of determining the position of the inflection point even under such conditions because the method carries out not only second differentiation, but also third differentiation. That adds to the general applicability of the method in accordance with the present invention.

The method of determining a position of the illumination means in accordance with the present invention is furthermore preferably such that the inflection point is a point at which the second derivative has a minimum moving standard deviation in a two-dot-cycle range stretching over a point at which the third derivative equals 0.

The method obtains a point at which the third derivative equals 0 to roughly determine an inflection point and then obtains a point at which the second derivative has a minimum moving standard deviation in a two-dot-cycle range stretching over the roughly determined inflection point. Therefore, the position of the inflection point can be more invariably determined. The method thus further cuts short the time taken to determine the optimal light source position which could vary from one inspection object to the other. The method also further improves irregularity detection precision of the irregularity inspection device.

The method of determining a position of the illumination means in accordance with the present invention is preferably such that the fourth step is carried out by comparing the inspection object with a reference sample having a definite reflection plane disappearance position.

It may be difficult to directly detect the reflection plane disappearance position, depending on the shape of the inspection object. The method images a reference sample with a known reflection plane disappearance position or a reference sample of a shape from which the reflection plane disappearance position is easily obtainable and indirectly obtains the reflection plane disappearance position of the inspection object from the position of the inflection point of the reference sample, the reflection plane disappearance position, and the position of the inflection point of the inspection object by utilizing a proportional relationship. Thus, the method reduces effect of the shape of the inspection object. That adds to the general applicability of the method in accordance with the present invention.

The method of determining a position of the illumination means in accordance with the present invention is preferably such that at least two position determining images are generated.

The method more accurately determines the position of the inflection point because the method uses more resources based on which the position of the inflection point is determined than in cases where there is only one position determining image being involved. The method thus further cuts short the time taken to determine the optimal light source position which could vary from one inspection object to the other. The method also further improves irregularity detection precision of the irregularity inspection device.

A method of inspecting for irregularities in accordance with the present invention is a method of inspecting for irregularities involving projecting light illuminating a linear part of a film surface and receiving light reflected off the film surface onto which light is projected, in order to detect an irregularity of a surface mound from other surface mounds caused by deviation in thickness in a specific direction on an inspection object including a film having very small, orderly arranged surface mounds, the method including a method of determining a position of illumination means in accordance with the present invention.

The method of determining a position of the illumination means in accordance with the present invention detects a site where the amount of reflected light undergoes a large change to determine the site as the position of the illumination means. The method thus cuts short the time taken to determine the optimal light source position which could vary from one inspection object to the other. The method also improves irregularity detection precision of an irregularity inspection device. Therefore, the method of inspecting for irregularities including the method precisely detects irregularities on the inspection object in less time.

An irregularity inspection device in accordance with the present invention includes: illumination means for projecting light illuminating a linear part of a film surface of an inspection object including a film having very small, orderly arranged surface mounds; imaging means for receiving light reflected off the film surface onto which light is projected, to generate a position determining image; calibration means for determining, based on the position determining image, an optimal position of the illumination means, to receive light reflected at a center position which is a halfway point between an inflection point of luminance of the light reflected off the film surface and a reflection plane disappearance position on the film at which the luminance of the reflected light equals 0 and which is next to a position where non-zero luminance is observed; and inspection means for detecting an irregularity on the inspection object based on an irregularity inspection image obtained by receiving, on the imaging means, reflection off the inspection object of the light projected by the illumination means located at the determined position of the illumination means onto the inspection object.

The device detects a site where the amount of the reflected light undergoes a large change, determines the site as the position of the illumination means, and inspects for irregularities based on the irregularity inspection image produced by receiving the reflection of the light projected onto the inspection object from an optimal light source position. The device thus cuts short the time taken to determine the optimal light source position which could vary from one inspection object to the other. The device also achieves high irregularity detection precision. The device only needs to include the illumination means, the imaging means, the calibration means, and the inspection means. The device therefore does not require a complex structure. The device is relatively simple.

The irregularity inspection device in accordance with the present invention is preferably such that the calibration means includes: other illumination means for projecting light illuminating a linear part of the film surface and other imaging means for receiving light reflected off the film surface onto which light is projected, to generate a position determining image.

In the device, the calibration means includes illumination means and imaging means for use in determining the position of the illumination means that is provided in the irregularity inspection device, apart from the illumination means and the imaging means that are included in the irregularity inspection device for the detection of irregularities. The illumination means and the imaging means that are included for the detection of irregularities are moved less often. The device is thus capable of inspecting for irregularities in less time.

The irregularity inspection device in accordance with the present invention is preferably such that the imaging means is an area sensor camera or a line sensor camera.

The area sensor camera is inferior to the line sensor camera in resolution and speed, but inexpensive. The area sensor camera, unlike the line sensor camera, requires no auxiliary scanning in which the inspection object is moved. Therefore, the area sensor camera is effective in simple inspection and contributes to cost reduction.

In contrast, the line sensor camera readily offers necessary high resolution, as well as superb signal SN ratios and dynamic ranges, delivering high quality images. In addition, auxiliary scanning is performed by moving the inspection target, which enables continuous, high-speed image capturing. Therefore, the line sensor camera is effective in high-precision inspection.

A light source position determining device in accordance with the present invention includes: illumination means for projecting light illuminating a linear part of a film surface of an inspection object including a film having very small, orderly arranged surface mounds; imaging means for receiving light reflected off the film surface onto which light is projected, to generate a position determining image; and calibration means for determining, based on the position determining image, an optimal position of the illumination means, to receive light reflected at a center position which is a halfway point between an inflection point of luminance of the light reflected off the film surface and a reflection plane disappearance position on the film at which the luminance of the reflected light equals 0 and which is next to a position where non-zero luminance is observed.

The device determines the position of the inflection point of the luminance of the reflected light and the reflection plane disappearance position based on the position determining image. The device then obtains the tilt angle based on these positions. Thus, the device is capable of detecting a site where the amount of the reflected light undergoes a large change and determining the site as the position of the illumination means. The device thus cuts short the time taken to determine the position of the light source for an irregularity inspection device. The device also improves irregularity detection precision of the irregularity inspection device.

A method of measuring a peripheral tilt angle in accordance with the present invention is, to address the problems, adapted so that the method is a method of measuring a peripheral tilt angle on an inspection object having surface mounds and includes: the step A of projecting light onto the inspection object; the step B of sensing distribution of light reflected off the inspection object; the step C of obtaining a feature point of the distribution of the reflected light from result of the sensing of the distribution of the reflected light; and the step D of obtaining a peripheral tilt angle which is a tilt angle near a periphery of each of the surface mounds based on an angle of projection of the light in step A to a position which, on the inspection object, corresponds to the feature point and an angle of sensing of the reflected light in step B off a position which, on the inspection object, corresponds to the feature point.

Therefore, the method provides a useful indicator for precise detection of deviation in thickness on the inspection object.

An inspection method of the present invention is adapted so that the method is an inspection method of detecting a deviation in height of surface mounds on an inspection object and includes: the step A of projecting light onto the inspection object; the step B of sensing distribution of light reflected off the inspection object; the step C of obtaining a feature point of the distribution of the reflected light from result of the sensing of the distribution of the reflected light; the step D of obtaining a peripheral tilt angle which is a tilt angle near a periphery of each of the surface mounds based on an angle of projection of the light in step A to a position which, on the inspection object, corresponds to the feature point and an angle of sensing of the reflected light in step B off a position which, on the inspection object, corresponds to the feature point; and the step E of, using an inspection device including illumination means for projecting light onto the inspection object and sensing means for sensing reflection of the projected light off the inspection object, determining relative positions of the illumination means, the inspection object, and the sensing means so that the light projected onto the inspection object is reflected off a part of the inspection object which has a tilt angle greater than or equal to the peripheral tilt angle and also that the reflected light is incident to the sensing means.

The method precisely detects the deviation in height of the surface mounds.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and the scope of the invention as hereinafter claimed.

### INDUSTRIAL APPLICABILITY

The present invention is applicable to the inspection of a semiconductor and a light emitting layer of an organic EL having a cyclic pattern in which a linear irregularity could occur in a particular direction. The invention is therefore suited for use in the field of image display, especially, color image display.

1. A method of measuring a peripheral tilt angle on an inspection object having surface mounds, said method comprising:
the step A of projecting light onto the inspection object;
the step B of sensing distribution of light reflected off the inspection object;
the step C of obtaining a feature point of the distribution of the reflected light from result of the sensing of the distribution of the reflected light; and
the step D of obtaining a peripheral tilt angle which is a tilt angle near a periphery of each of the surface mounds based on an angle of projection of the light in step A to a position which, on the inspection object, corresponds to the feature point and an angle of sensing of the reflected light in step B off a position which, on the inspection object, corresponds to the feature point.

2. An inspection method of detecting a deviation in height of surface mounds on an inspection object, said method comprising:
the step A of projecting light onto the inspection object;
the step B of sensing distribution of light reflected off the inspection object;
the step C of obtaining a feature point of the distribution of the reflected light from result of the sensing of the distribution of the reflected light;
the step D of obtaining a peripheral tilt angle which is a tilt angle near a periphery of each of the surface mounds based on an angle of projection of the light in step A to a position which, on the inspection object, corresponds to the feature point and an angle of sensing of the reflected light in step B off a position which, on the inspection object, corresponds to the feature point; and
the step E of, using an inspection device including illumination means for projecting light onto the inspection object and sensing means for sensing reflection of the projected light off the inspection object, determining relative positions of the illumination means, the inspection object, and the sensing means so that the light projected onto the inspection object is reflected off a part of the inspection object which has a tilt angle greater than or equal to the peripheral tilt angle and also that the reflected light is incident to the sensing means.

3. The inspection method according to claim 2, wherein the relative positions of the illumination means, the inspection object, and the imaging means are determined so that the sensing means is disposed on a line which is an extension of a path followed by the reflection of the light projected onto the inspection object off one of the surface mounds which, on the inspection object, has an angle between (a) the peripheral tilt angle and (b) a reflection plane disappearance angle which is an angle of a surface of that surface mound at a position which, on the inspection object, corresponds to a position where no light is observable according to the distribution of the reflected light.

4. The inspection method according to claim 2, wherein the feature point is an inflection point in data obtained by one-dimensional projection of data on the distribution of the reflected light.

5. The inspection method according to claim 4, wherein:
the inflection point is obtained by subjecting to first differentiation the data obtained by one-dimensional projection of the data on the distribution of the reflected light for a first derivative and subjecting further to second differentiation a slope of luminosity distribution obtained by the first differentiation for a second derivative; and
the second derivative equals 0 at the inflection point.

6. The inspection method according to claim 5, further wherein the inflection point is a point at which the first derivative has a minimum moving standard deviation in a two-dot-cycle range stretching over a point at which the second derivative equals 0.

7. The inspection method according to claim 5, wherein:
the inflection point is obtained by subjecting to first differentiation the data obtained by one-dimensional projection of the data on the distribution of the reflected light, subjecting to second differentiation a slope of luminosity distribution obtained by the first differentiation for a second derivative, and subjecting the second derivative to third differentiation for a third derivative; and
the third derivative equals 0 at the inflection point.

8. The inspection method according to claim 7, further wherein the inflection point is a point at which the second derivative has a minimum moving standard deviation in a two-dot-cycle range stretching over a point at which the third derivative equals 0.

9. The inspection method according to claim 3, wherein the reflection plane disappearance angle is obtained by comparing the inspection object with a reference sample having a definite reflection plane disappearance position.

10. The inspection method according to claim 2, wherein the distribution of the reflected light is sensed at least twice.

11. The inspection method according to claim 2, wherein the feature point is obtained based on reflection data on light reflected off particular surface mounds in the distribution of the reflected light.

12. The inspection method according to claim 11, wherein:
at least two different surface mounds are selected as the particular surface mounds; and
a feature point is obtained for each of the particular surface mounds based on reflection data on light reflected off those surface mounds.

13. The inspection method according to claim 2, wherein the feature point(s) is/are obtained based on the data on the distribution of the reflected light for each color of the surface mounds.

14. The inspection method according to claim 13, wherein when the feature point(s) is/are obtained based on the data on the distribution of the reflected light for each color of the surface mounds, the feature point(s) is/are obtained based on data other than the data on the distribution of the reflected light about halfway between two surface mounds of different colors.

15. An inspection device, comprising:
illumination means for projecting light onto an inspection object having surface mounds;
sensing means for sensing distribution of reflection off the inspection object onto which light is projected;
feature point detection means for obtaining a feature point in the distribution of the reflection from result of the sensing of the distribution of the reflection; and
tilt angle calculation means for obtaining a peripheral tilt angle which is a tilt angle near a periphery of each of the surface mounds based on an angle of projection of the light to a position which, on the inspection object, corresponds to the feature point and an angle of the sensing by the sensing means of the reflection off a position which, on the inspection object, corresponds to the feature point.

16. A method of determining a position of illumination means, said method being implemented by an irregularity inspection device including illumination means for projecting light illuminating a linear part of a film surface and imaging means for receiving light reflected off the film surface onto which light is projected, in order to detect, on an inspection object including the film having very small, orderly arranged surface mounds, an irregularity caused by deviation in thickness in a specific direction of a surface mound from other surface mounds, said method comprising:
the first step of projecting light onto the film on the inspection object;
the second step of receiving the light reflected off the film on the inspection object to generate a position determining image;
the third step of obtaining, based on the position determining image, a distance between an inflection point of luminance of the reflected light and a regular reflection position at which the projected light undergoes regular reflection off the film on the inspection object, to determine a position of the inflection point;
the fourth step of obtaining a distance between the regular reflection position and a reflection plane disappearance position on the film at which the luminance of the reflected light equals 0 and which is next to a position where non-zero luminance is observed, to determine a position of the reflection plane disappearance position;
the fifth step of obtaining a center position which is a halfway point between the position of the inflection point and the reflection plane disappearance position;
the sixth step of obtaining a tilt angle of the film at the center position with respect to a plane of the inspection object by equation 1,
$$\begin{matrix}[ Eq . 1 ] & \\ {θ}_{c} = \frac{α - β}{2} \\ where \\ α = {tan}^{- 1} ( \frac{{L}_{1} + {X}_{c}}{{H}_{1}} ) \\ β = {tan}^{- 1} ( \frac{{L}_{2} - {X}_{c}}{{H}_{2}} ) & ( Eq . 2 )\end{matrix}$$
α being an angle between a normal to the plane of the inspection object passing through the center position and the light projected by the illumination means incident at the center position, and β being an angle between the normal and light reflected at the center position to the imaging means; and
the seventh step of determining an optimal position of the illumination means for receiving the light reflected at the center position from the tilt angle by equation 2,
[Eq. 2]
X_{L}=tan(2θ_{c}+θᵢ)·D cos θᵢ−D sin θᵢ (Eq. 3)

17. An irregularity inspection device, comprising:
illumination means for projecting light illuminating a linear part of a film surface of an inspection object including a film having very small, orderly arranged surface mounds;
imaging means for receiving light reflected off the film surface onto which light is projected, to generate a position determining image;
calibration means for determining, based on the position determining image, an optimal position of the illumination means, to receive light reflected at a center position which is a halfway point between an inflection point of luminance of the light reflected off the film surface and a reflection plane disappearance position on the film at which the luminance of the reflected light equals 0 and which is next to a position where non-zero luminance is observed; and
inspection means for detecting an irregularity on the inspection object based on an irregularity inspection image obtained by receiving, on the imaging means, reflection off the inspection object of the light projected by the illumination means located at the determined position of the illumination means onto the inspection object.

18. The irregularity inspection device according to claim 17, wherein the calibration means includes: other illumination means for projecting light illuminating a linear part of the film surface and other imaging means for receiving light reflected off the film surface onto which light is projected, to generate a position determining image.

19. The irregularity inspection device according to claim 17, wherein the imaging means is an area sensor camera or a line sensor camera.

20. A light source position determining device, comprising:
illumination means for projecting light illuminating a linear part of a film surface of an inspection object including a film having very small, orderly arranged surface mounds;
imaging means for receiving light reflected off the film surface onto which light is projected, to generate a position determining image; and
calibration means for determining, based on the position determining image, an optimal position of the illumination means, to receive light reflected at a center position which is a halfway point between an inflection point of luminance of the light reflected off the film surface and a reflection plane disappearance position on the film at which the luminance of the reflected light equals 0 and which is next to a position where non-zero luminance is observed.
